(19) United States
(12) Patent Application Publication
(10) Pub. No.: US 2026/0358805 A1
(43) Pub. Date: Nov. 12, 2026

(54) GRID-FREE PERCEPTION TASKS

(71) Applicant: QUALCOMM Incorporated, San Diego, CA (US)

(72) Inventors: Andreas SJOEDIN HAELLSTRAND, Stockholm (SE); Meysam SADEGHIGOOGHARI, Linkoping (SE)

(21) Appl. No.: 19/661,551

(22) Filed: Apr. 28, 2026

Related U.S. Application Data
(60) Provisional application No. 63/801,772, filed on May 7, 2025.

(51) Int. Cl. G05D 1/24; G05D 1/622

(52) U.S. Cl. CPC G05D 1/24; G05D 1/622

(57) ABSTRACT

Systems and techniques are described herein for processing data. For instance, a method for processing data is provided. The method may include processing sensor data from one or more sensors to generate bird's-eye-view (BEV) features; processing the BEV features using a processing head to generate an output, wherein the output comprises a number of predictions, and wherein each prediction of the number of predictions comprises a respective anchor point and a respective offset relative to the respective anchor point; and adjusting an operating parameter of a vehicle based on the output.

### CROSS-REFERENCE TO RELATED APPLICATIONS

This application claims the benefit of US Provisional Application No. 63/801,772, filed May 7, 2025, which is incorporated herein by reference in its entirety.

### TECHNICAL FIELD

The present disclosure generally relates to perception tasks. For example, aspects of the present disclosure include systems and techniques for grid-free perception tasks.

### BACKGROUND

Bird's-eye-view (BEV) perception tasks are used in autonomous driving and advanced driver-assistance systems (ADAS). BEV perception tasks include, as examples, object detection, environmental mapping, three-dimensional (3D) localization, etc.

Prior to performing perception tasks, data from different sensors (e.g., image data from cameras, radio detection and ranging (RADAR) data from radar systems, and/or light detection and ranging (LIDAR) data from lidar systems) is processed and fused in a BEV space. Then, task-specific heads are applied to the fused data. Such task-specific heads include, for example, an environmental modeling head, a map construction head, an object detection head, etc.

### SUMMARY

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary presents certain concepts relating to one or more aspects relating to the mechanisms disclosed herein in a simplified form to precede the detailed description presented below.

Systems and techniques are described for processing data. According to at least one example, a method is provided for processing data. The method includes: processing sensor data from one or more sensors to generate bird's-eye-view (BEV) features; processing the BEV features using a processing head to generate an output, wherein the output comprises a number of predictions, and wherein each prediction of the number of predictions comprises a respective anchor point and a respective offset relative to the respective anchor point; and adjusting an operating parameter of a vehicle based on the output.

In another example, an apparatus for processing data is provided that includes at least one memory and at least one processor (e.g., configured in circuitry) coupled to the at least one memory. The at least one processor configured to: process sensor data from one or more sensors to generate bird's-eye-view (BEV) features; process the BEV features using a machine-learning model to generate an output, wherein the output comprises a number of predictions, and wherein each prediction of the number of predictions comprises a respective anchor point and a respective offset relative to the respective anchor point; and adjust an operating parameter of a vehicle based on the output.

In another example, a non-transitory computer-readable medium is provided that has stored thereon instructions that, when executed by one or more processors, cause the one or more processors to: process sensor data from one or more sensors to generate bird's-eye-view (BEV) features; process the BEV features using a machine-learning model to generate an output, wherein the output comprises a number of predictions, and wherein each prediction of the number of predictions comprises a respective anchor point and a respective offset relative to the respective anchor point; and adjust an operating parameter of a vehicle based on the output.

In another example, an apparatus for processing data is provided. The apparatus includes: means for processing sensor data from one or more sensors to generate bird's-eye-view (BEV) features; means for processing the BEV features using a processing head to generate an output, wherein the output comprises a number of predictions, and wherein each prediction of the number of predictions comprises a respective anchor point and a respective offset relative to the respective anchor point; and means for adjusting an operating parameter of a vehicle based on the output.

In some aspects, one or more of the apparatuses described herein is, can be part of, or can include an extended reality device (e.g., a virtual reality (VR) device, an augmented reality (AR) device, or a mixed reality (MR) device), a vehicle (or a computing device, system, or component of a vehicle), a mobile device (e.g., a mobile telephone or so-called “smart phone”, a tablet computer, or other type of mobile device), a smart or connected device (e.g., an Internet-of-Things (IoT) device), a wearable device, a personal computer, a laptop computer, a video server, a television (e.g., a network-connected television), a robotics device or system, or other device. In some aspects, each apparatus can include an image sensor (e.g., a camera) or multiple image sensors (e.g., multiple cameras) for capturing one or more images. In some aspects, each apparatus can include one or more displays for displaying one or more images, notifications, and/or other displayable data. In some aspects, each apparatus can include one or more speakers, one or more light-emitting devices, and/or one or more microphones. In some aspects, each apparatus can include one or more sensors. In some cases, the one or more sensors can be used for determining a location of the apparatuses, a state of the apparatuses (e.g., a tracking state, an operating state, a temperature, a humidity level, and/or other state), and/or for other purposes.

This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

The foregoing, together with other features and aspects, will become more apparent upon referring to the following specification, claims, and accompanying drawings.

### BRIEF DESCRIPTION OF THE DRAWINGS

Illustrative examples of the present application are described in detail below with reference to the following figures:

FIG. 1A illustrates a vehicle that includes multiple sensors coupled to vehicle at different positions (e.g., a surround-camera configuration);

FIG. 1B is a diagram including two example representations of outputs of a grid-based lane-marking detector as an example to illustrate deficiencies of grid-based BEV perception tasks;

FIG. 2 is a diagram illustrating a number of example anchor points relative to an example ego platform (e.g., a vehicle) to provide context for a description of the systems and techniques;

FIG. 3 is a diagram including an example representation of prior arrangement of anchor points (e.g., a prior to a detector) an output arrangement of offset points 314 (e.g., an output of a detector);

FIG. 4 is a diagram including two additional example representations of output arrangements according to various aspects of the present disclosure;

FIG. 5 is a block diagram illustrating an example system for performing grid-based BEV perception tasks;

FIG. 6 is a block diagram illustrating an example system for performing BEV perception tasks, according to various aspects of the present disclosure;

FIG. 7 is a flow diagram illustrating an example process for preparing a model to perform BEV perception tasks, according to various aspects of the present disclosure;

FIG. 8 is a diagram including an example representations of output arrangements according to various aspects of the present disclosure;

FIG. 9A and FIG. 9B include representations of detection outputs of a grid-based BEV lane-detection task and a representation of detection outputs of a lane-detection task according to various aspects of the present disclosure;

FIG. 10 is a block diagram illustrating an example system that may perform a perception task, according to various aspects of the present disclosure;

FIG. 11 includes a representation of non-uniformly distributed anchor-point distribution, according to various aspects of the present disclosure;

FIG. 12 includes a representation of an example anchor-point distribution, according to various aspects of the present disclosure;

FIG. 13 is a block diagram illustrating an example system that may perform a perception task and provide instance information, according to various aspects of the present disclosure;

FIG. 14 includes a representation of an example BEV space and a related example embedding space, according to various aspects of the present disclosure;

FIG. 15 is a block diagram illustrating an example system that may perform a perception task and provide instance information, according to various aspects of the present disclosure;

FIG. 16 is a block diagram illustrating an example system that may perform a perception task and provide instance information, according to various aspects of the present disclosure;

FIG. 17 is a flow diagram illustrating an example process for processing data, in accordance with aspects of the present disclosure;

FIG. 18 is a block diagram illustrating an example of a deep learning neural network that can be used to perform various tasks, according to some aspects of the disclosed technology;

FIG. 19 is a block diagram illustrating an example of a convolutional neural network (CNN), according to various aspects of the present disclosure; and

FIG. 20 is a block diagram illustrating an example computing-device architecture of an example computing device which can implement the various techniques described herein.

### DETAILED DESCRIPTION

Certain aspects of this disclosure are provided below. Some of these aspects may be applied independently and some of them may be applied in combination as would be apparent to those of skill in the art. In the following description, for the purposes of explanation, specific details are set forth in order to provide a thorough understanding of aspects of the application. However, it will be apparent that various aspects may be practiced without these specific details. The figures and description are not intended to be restrictive.

The ensuing description provides example aspects only, and is not intended to limit the scope, applicability, or configuration of the disclosure. Rather, the ensuing description of the exemplary aspects will provide those skilled in the art with an enabling description for implementing an exemplary aspect. It should be understood that various changes may be made in the function and arrangement of elements without departing from the spirit and scope of the application as set forth in the appended claims.

The terms “exemplary” and/or “example” are used herein to mean “serving as an example, instance, or illustration.” Any aspect described herein as “exemplary” and/or “example” is not necessarily to be construed as preferred or advantageous over other aspects. Likewise, the term “aspects of the disclosure” does not require that all aspects of the disclosure include the discussed feature, advantage, or mode of operation.

As mentioned above, bird's-eye-view (BEV) perception tasks (e.g., perception tasks that operate on input data in a BEV space and generate outputs in the BEV space) are used in autonomous driving and advanced driver-assistance systems (ADAS). BEV perception tasks include, as examples, object detection, environmental mapping, three-dimensional (3D) localization, etc.

Prior to performing perception tasks, data from one or more sensors (e.g., image data from cameras, radio detection and ranging (RADAR) data from radar systems, and/or light detection and ranging (LIDAR) data from lidar systems) is processed and fused in a BEV space (e.g., as BEV features). Then, task-specific heads are applied to the BEV features. Such task-specific heads include, for example, an environmental-modeling head, a map-construction head, an object-detection head, etc. Generally the task-specific heads generate outputs that are also in the BEV space (e.g., detections in a BEV map). In the present disclosure, the term “head” may refer to one or more layers of a machine-learning model trained to perform a task. A head may operate on features encoded by a backbone. For example, a detection head may detect objects in a BEV space based on BEV features.

This disclosure uses the term BEV in multiple contexts. BEV features and BEV outputs may represent different data types. In some aspects, BEV features may include a latent feature representation generated by projecting and/or fusing sensor data into an ego-centric top-down coordinate system. Separately, a task head may process the BEV features to generate a BEV output representation that encodes predicted entities (e.g., objects and/or map elements) in BEV coordinates. For example, the BEV output representation may include predicted points, predicted bounding boxes, and/or predicted map-element samples, along with associated attributes.

It is common to process BEV features according to a grid-based process. For example, task-specific heads may predict attributes of each cell of a grid of cells of a BEV grid. For example, an object-detection task may predict a Gaussian heatmap for a grid. The grid may be used for 3D-object detection. As another example, another object detector may perform a classification per cell of a BEV grid to determine if each cell has an object or not. The object detector may use a regression to find the exact location of the object within the cell.

Such grid-based approaches suffer from several issues, due to their inherent grid-based design. For example, according to a grid-based approach, an object detector may only be able to detect a predetermined number of objects per cell.

For example, in some cases, an object detector may be capable of detecting at most one object per cell. To increase the number of objects detectable by such an object detector, a number of cells of the grid may be increased. However, increasing the number of cells of a grid may increase computation costs (e.g., processing time, processing power, memory usage, and/or communication bandwidth). Additionally, if grid sizes are too small, objects may extend into multiple cells, which may introduce quantization errors.

As another example, to increase the number of objects detectable by an object detector, the object detector may be instructed to detect a predetermined number of objects per cell. Increasing the number of objects for the object detector to detect in each cell to a number “K” may increase the computation costs by a factor of K!.

In some grid-based approaches, a task head may be configured to output K candidate detections per grid cell to represent multiple objects that overlap a same cell. Selecting K to cover worst-case dense scenes may increase computation cost and/or memory usage for all cells, including cells that include no object or a single object, thereby wasting resources. Additionally, because a majority of grid cells may correspond to background, training a grid-based output may yield a class-imbalance condition between background cells and foreground cells, which may reduce training stability and/or accuracy.

Further, grid-based outputs of BEV perception tasks have issues. For example, an output of a BEV perception tasks may be rasterized (e.g., outputs may be partitioned into cells of a BEV grid). The rasterization (e.g., partitioning data into the BEV grid), in conjunction with the requirement that only one object can be in each grid cell may cause aliasing patterns (e.g., along lines, for example, two separate parallel lines). For example, an aliasing pattern is observable when detecting two parallel lines using a grid-based BEV object detector. This is due to the fact that detections of two parallel lines sometimes align so that both lines are encompassed by a single grid cell, resulting in only one of the lines being represented there.

Grid-based BEV perception tasks suffer from deficient modeling. For example, it may be computationally expensive for a grid-based BEV perception tasks to detect multiple closely-spaced objects (e.g., pedestrians, vehicles, lane markings, etc.). Additionally, grid-based BEV perception tasks may introduce quantization errors that creates artifacts in predictions. This can cause jumps in the predictions provided by grid-based BEV perception tasks, discontinuity of predicted instances, missing instances, etc.

Systems, apparatuses, methods (also referred to as processes), and computer-readable media (collectively referred to herein as “systems and techniques”) are described herein for a grid-free, anchor-based approach to BEV perception tasks. For example, the systems and techniques described herein may perform various BEV perception tasks making predictions based on anchor points and offsets from the anchor points (e.g., rather than predictions based on cells of a BEV grid).

For example, contrary to grid-based BEV perception tasks, the systems and techniques include grid-free heads where each head makes a fixed number of predictions (e.g., 100). For each such prediction, the systems and techniques determine a point in 2D (or 3D) around an ego platform (e.g., an ego vehicle). The predetermined point of each prediction may be referred to as a “point anchor,” an “anchor point” or an “anchor.”

According to various aspects of the present disclosure, each head may predict a set of attributes for each of its predictions. One of such attributes is a 2D/3D (Δx, Δy, Δz) offset that enables the prediction to localize the object of interest. For example, an offset may describe an x, y, and/or z displacement between the anchor point a position associated with the prediction. Other such attributes depend on the head. Some examples of attributes are height, width, length, yaw, pitch, roll, velocity, class, etc.

For each head the systems and techniques assign objects of interest to its predictions, and during training, the systems and techniques create losses accordingly so that for each prediction the attributes (including offsets) are predicted.

In some aspects, multiple anchor points may be capable of representing a same ground-truth element (e.g., because multiple anchors lie within a threshold distance of the element). During training, systems and techniques may select, for each ground-truth element, one or more responsible predictions among candidate predictions based on a matching cost. Example matching costs may weight Euclidean distance between an offset point and the ground-truth element, an existence-confidence score, a class score, and/or another attribute.

The systems and techniques may train responsible predictions to output high existence confidence and accurate attributes for the ground-truth element. The systems and techniques may also train non-responsible candidate predictions (including predictions having anchor points near the ground-truth element) to output a background class and/or low existence confidence. This training-driven responsibility assignment may reduce ambiguity that can otherwise occur when a ground-truth element lies near multiple anchors.

One major advantage of such a grid-free design is that the offsets are now free to have any length. This enable the systems and techniques to do 3D object detection and perception efficiently even for dense scenarios (e.g., including groups of pedestrians, etc.) without extra cost. Additionally, because the systems and techniques use a fixed number of predictions, the systems and techniques can easily scale (e.g., to cover longer ranges without extra cost).

Anchor points may be, or may include, 2D/3D locations (e.g., around an ego platform). Offsets may be defined relative to respective anchor points. This enables the systems and techniques to explicitly introduce inductive biases and reduce the need for data, compared to other approaches, such as transformer/detection transformer (DETR) based approaches.

In grid-based BEV perception tasks, instances that fall on or close to cell boundaries can cause jumps in detections, thickening effects, rasterization effects, etc. The systems and techniques exhibit such issues by design.

Using point anchors enables the systems and techniques to go beyond object detection and cover applications like HD map constructions and environment modelling, as the systems and techniques can model map elements (e.g., a solid lane marking) using a set of such predictions.

Additionally, the present disclosure describes multiple approaches for the distribution of anchor points to boost performance. For example, the systems and techniques may use data-driven anchor-point distributions. Data-driven anchor-point distribution is feasible based on the grid-free design of the systems and techniques.

Additionally, the present disclosure describes multiple methods for extending object detection to instance detection based on the grid-free design of the systems and techniques. Further, the systems and techniques extend seamlessly to multi-task scenarios.

Various BEV-based perception tasks can be implemented according to various aspects of the present disclosure. For example, object detection tasks, map-making tasks, localization tasks, etc. can be implemented according to the anchor-based approach of the present disclosure.

Various examples provided herein relate to autonomous driving and/or ADAS. The systems and techniques are not limited to autonomous driving and/or ADAS. The systems and techniques may also be applied in robotics, and/or drones.

Various aspects of the application will be described with respect to the figures below.

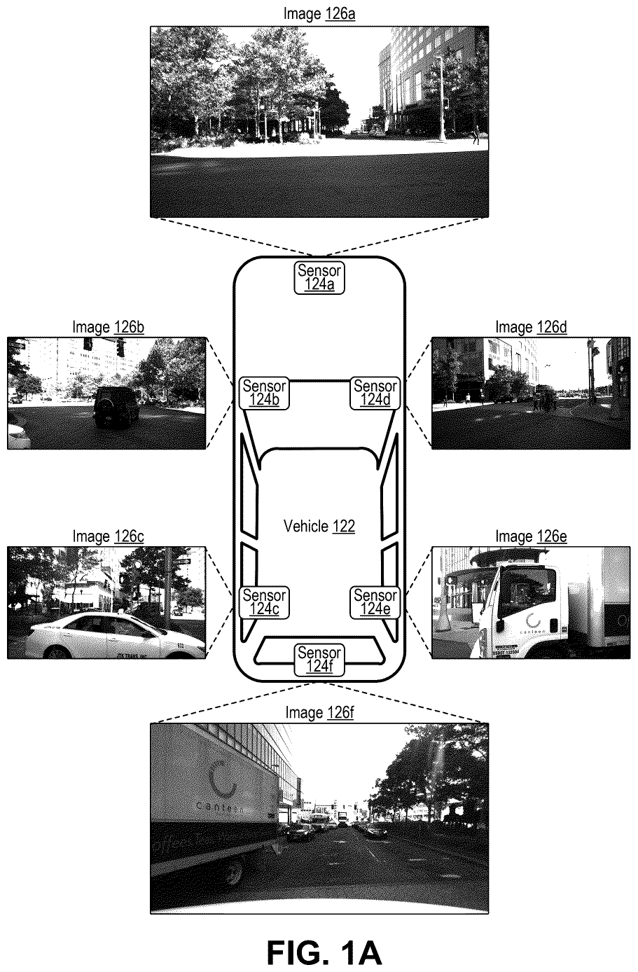

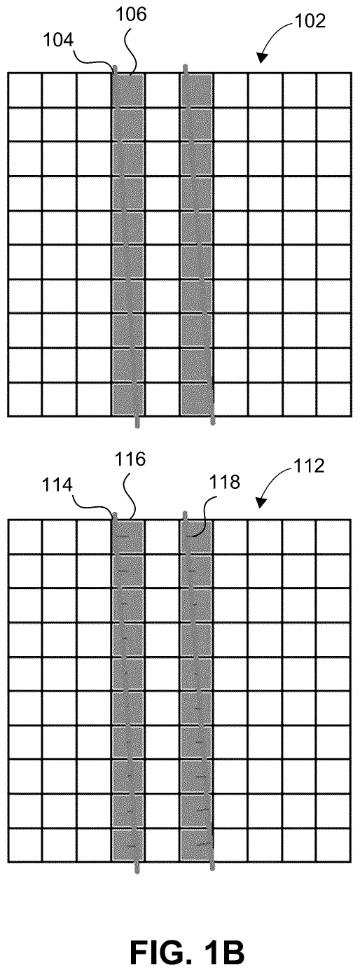

FIG. 1A illustrates a vehicle 122 that includes multiple sensors (e.g., sensors 124a, 124b, 124c, 124d, 124e, and 124f, collectively referred to as sensors 124a to 124f) that are coupled to vehicle 122 at different positions (e.g., a surround-camera configuration). Sensors 124a to 124f (e.g., image sensors such as cameras) may capture images 126a, 126b, 126c, 126d, 126e, and 126f (collectively referred to as images 126a to 126f) of an environment of vehicle 122 from different perspectives. For example, a front-facing sensor 124a can capture images (including image 126a) of the environment in front of the vehicle. As another example, a rear-facing sensor 124f can capture images (including image 126f) of the environment behind the vehicle. The systems and techniques may be implemented in systems (e.g., vehicles) including surround cameras. Additionally or alternatively, the systems and techniques may be implemented in systems including two or more cameras facing substantially the same direction (e.g., with different optics, such as to cover long and short range). Image data, such as images 126a to 126f may be processed to generate BEV features. Additionally or alternatively, LIDAR data and/or RADAR data (with or without image data) may be processed to generate BEV data.

FIG. 1B is a diagram including two example representations of outputs of a grid-based lane-marking detector as an example to illustrate deficiencies of grid-based BEV perception tasks. For example, a grid-based lane-marking detector may model an environment as a grid of cells of an output tensor. Each cell in the output tensor may have a shape including a width, a height, and a number of channels. The output tensor is modelled to correspond to a square area in the XY plane around an ego platform (e.g., a vehicle), with no overlap between the cells. Each cell is trained to report whether or not a lane marking overlaps the cell.

For example, BEV grid 102 includes a number of shaded cells 106. Shaded cells 106 indicate a detected lane marking. Lane marking 104 is an example of the location of the lane marking overlaid onto BEV grid 102 to illustrate the correspondence between shaded cells 106 and the actual position of the lane markings.

In some cases, an offset from a center of each cell is estimated to accurately indicate where the lane marking is. For example, BEV grid 112 includes offsets 118 indicating distances between a center of each of shaded cells 116 and a predicted position of the lane markings. Lane marking 114 is an example of the location of the lane marking overlaid onto BEV grid 112 to illustrate the correspondence between offsets 118 and the actual position of the lane markings.

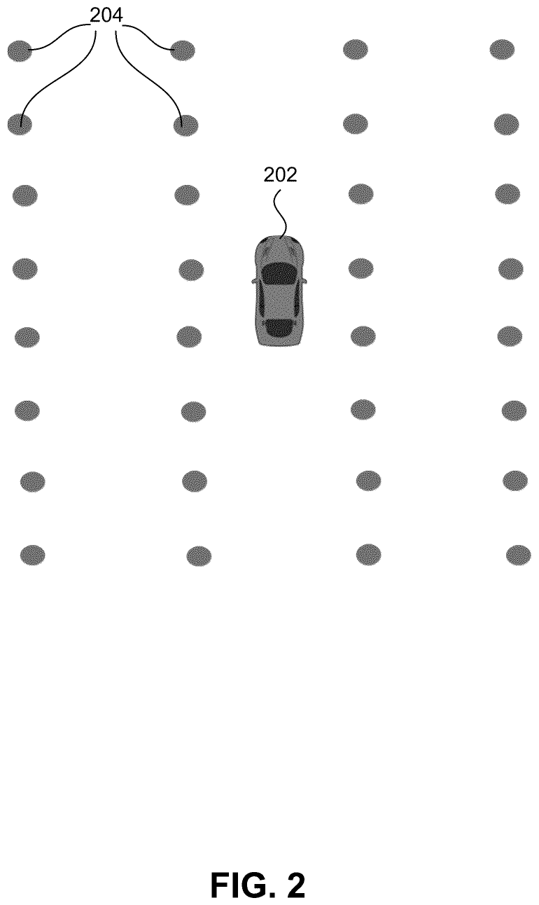

FIG. 2 is a diagram illustrating a number of example anchor points 204 relative to an example ego platform 202 (e.g., a vehicle) to provide context for a description of the systems and techniques. For example, the systems and techniques may include heads that predict a list (e.g., with a fixed size), where each element of the list is associated with a predefined point anchor (e.g., anchor points 204) which may be arranged in an XR plane around ego platform 202.

A grid-based BEV perception task may interpret outputs as a rasterized grid in the XY plane. For example, a grid-based BEV perception task may generate outputs as described with regard to BEV grid 102 and BEV grid 112 of FIG. 1B.

In contrast, the systems and techniques may model each output element as corresponding to a point anchor coordinate in the XY plane (e.g., anchor points 204). The systems and techniques may determine offsets from the point anchor coordinates. Thus each prediction may be unbounded (instead of being confined to within the outputs corresponding grid cell).

For example, the output elements can “move” in the XY plane wherever the head determines the output elements to fit. For example, an offset may describe a position of an output element relative to an anchor point of the output element. The systems and techniques can then output a high existence confidence if they are close to an actual lane.

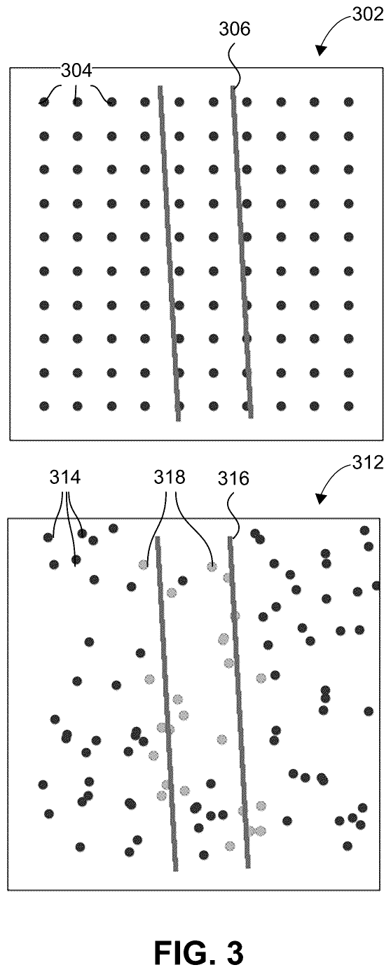

FIG. 3 is a diagram including an example representation of prior arrangement 302 of anchor points 304 (e.g., a prior to a detector) an output arrangement 312 of offset points 314 (e.g., an output of a detector). For example, prior arrangement 302 includes anchor points 304 in a uniform distribution. Lane marking 306 is an example of the location of the lane marking overlaid onto prior arrangement 302.

Output arrangement 312 includes offset points 314 and offset points 318. Each of offset points 314 and offset points 318 may be one of anchor points 304 after having been “moved” by a detector, according to various aspects of the present disclosure. For example, a detector may be tasked with detecting lane marking 316. The detector may output offset points 314 and offset points 318. Offset points 318 may indicate a detection of lane marking 316. In the present disclosure, the term “offset points” may refer to positions of output elements. Offset points may be an offset away from their anchor point.

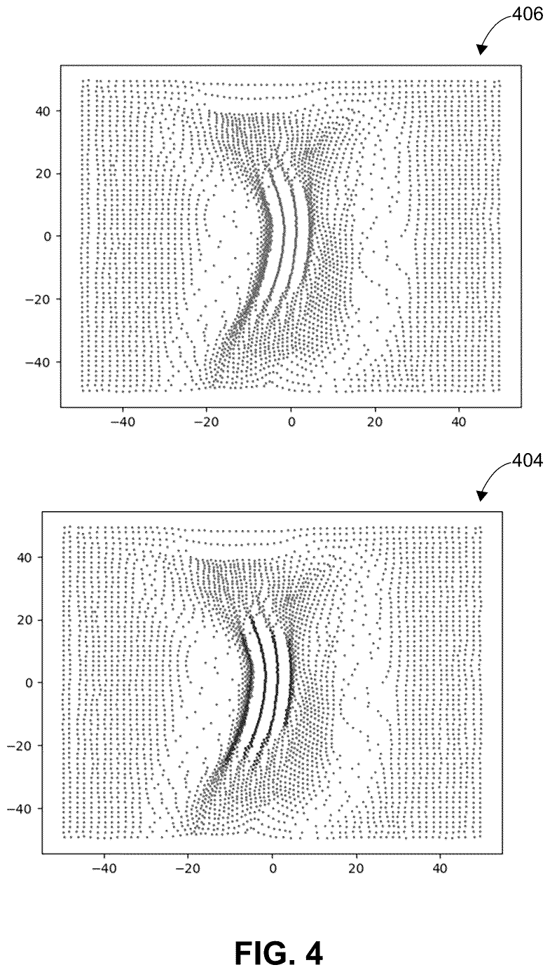

FIG. 4 is a diagram including two additional example representations of output arrangements according to various aspects of the present disclosure. For example, a trained network (e.g., a detector) may output predictions arranged as output arrangement 406. The darker points in output arrangement 404 represent thresholded predictions, representing the actual output passed to downstream tasks. As can be seen, output elements can cluster to the areas of interest, and fewer elements can be wasted on dead space. Doing this, the systems and techniques are able to switch from expressing the output as, for example, a 256×256 grid around the car, to instead a 64×64 list of predictions including anchor points and offsets. Using fewer predictions may conserve computational resources while still accurately representing predictions.

Contrary to grid-based BEV perception tasks, the systems and techniques include grid-free heads where each head has a fixed number of predictions. Having a fixed number of predictions renders the systems and techniques similar to transformer/DETR based approaches in the sense that transformer/DETR based approaches also have a fixed number of predictions. However, the systems and techniques differ from transformer/DETR based approaches because in the systems and techniques, the fixed number of predictions are not based on a fixed set of queries but based on a set of 2D/3D anchors which are distributed around ego vehicle, the point anchors.

For each of such anchors the systems and techniques predict a set of attributes. One of these attributes is a 2D/3D offset that enables the anchor to localize the object of interest (e.g., detected objects). Thanks to the grid-free design, the systems and techniques do not rely on cells and offsets are not bound to any cell. As the anchors are 2D/3D locations around the ego platform and offsets are defined relative to the anchors, the systems and techniques introduce inductive biases and reduce the need for data compared to transformer/DETR based solutions. Additionally, the systems and techniques can be used in convolutional neural networks (CNNs). Transformer-based approaches cannot be used in CNNs without sacrificing inductive bias and performance.

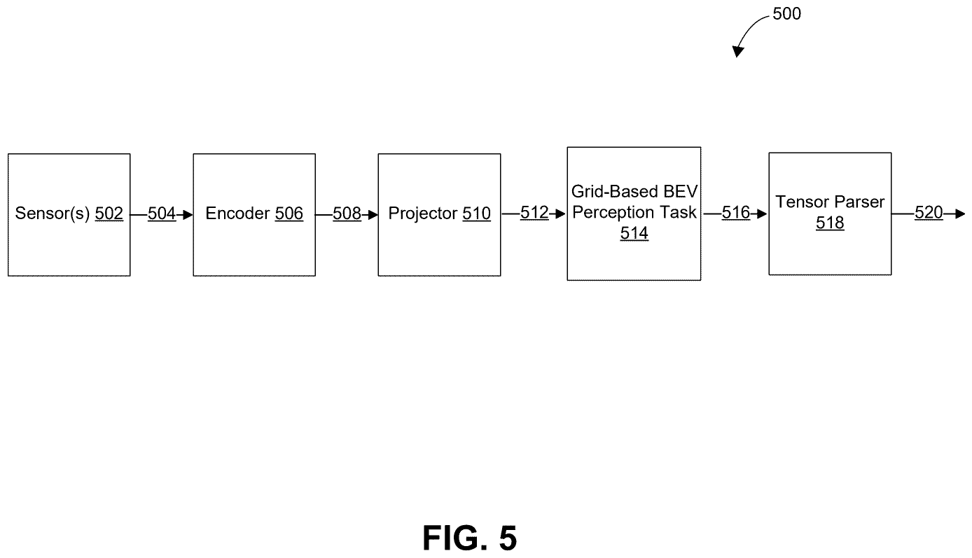

FIG. 5 is a block diagram illustrating an example system 500 for performing grid-based BEV perception tasks. Sensor(s) 502 may be, or may include, one or more sensors of one or more types. For example, sensor(s) 502 may include one or more cameras (e.g., arranged to face away from an ego platform at different angles). For example, sensor(s) 502 may include a front-facing camera, a rear-facing camera, and two side-facing cameras. Additionally or alternatively, sensor(s) 502 may include a light detection and ranging (LIDAR) system that may capture LIDAR image data and/or a radio detection and ranging (RADAR) system that may capture RADAR data.

Sensor data 504 may be, or may include, data representative of an environment of an ego platform (e.g., the platform including sensor(s) 502). Sensor data 504 may be, or may include, image data, LIDAR data, and/or RADAR data.

Encoder 506 may encode sensor data 504 to generate features 508. Encoder 506 may be, or may include, one or more machine-learning models trained to generate features based on sensor data (e.g., including image data, LIDAR data, and/or RADAR data).

Projector 510 may project features 508 into a BEV space to generate BEV features 512. For example, image features of features 508 may be in an image plane. Projector 510 may push the image features into a BEV space or pull data for cells of the BEV space from the image features.

Grid-based BEV perception task 514 may perform a task on BEV features 512 and generate output 516 as a result. For example, grid-based BEV perception task 514 may detect objects and output 516 as a BEV grid indicative of objects detected.

Tensor parser 518 may parse output 516 to generate output 520. For example, for each output channel with an estimated existence over a threshold, tensor parser 518 may output a prediction. Tensor parser 518 may read X and Y channels and their relative magnitude compared to the chosen quantization range and place the prediction somewhere in the area designated to each specific grid cell.

System 500 may output 520 to one or more downstream tasks. Example downstream tasks may include object detection, lane-marking detection, free-space estimation, map construction, environment modeling, localization, trajectory prediction, planning, and/or another downstream task that consumes BEV features.

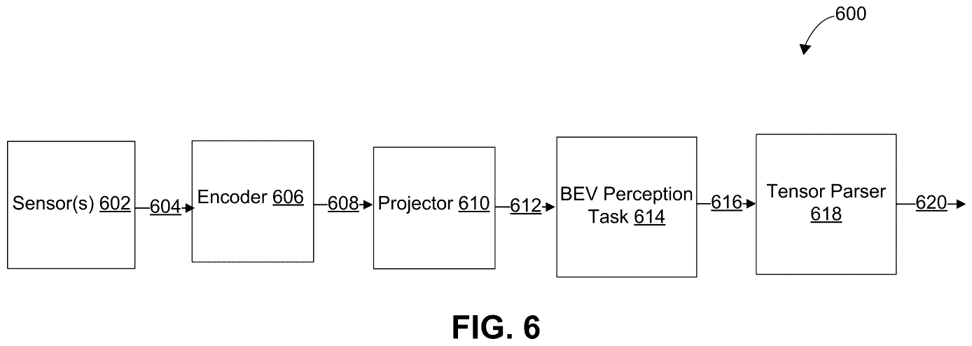

FIG. 6 is a block diagram illustrating an example system 600 for performing BEV perception tasks, according to various aspects of the present disclosure. For example, whereas grid-based BEV perception task 514 outputs grid-based output 516, BEV perception task 614 may generate output 616 without respect to a grid.

Sensor(s) 602 may be the same as, may be substantially similar to, and/or may perform the same, or substantially the same, operations as sensor(s) 502. Sensor data 604 may be the same as, or may be substantially similar to, sensor data 504. Encoder 606 may be the same as, or may be substantially similar to, encoder 506. Features 608 may be the same as, or may be substantially similar to, features 508. Projector 610 may be the same as, may be substantially similar to, and/or may perform the same, or substantially the same, operations as projector 510. BEV features 612 may be the same as, or may be substantially similar to, BEV features 512.

BEV perception task 614 may perform a task (e.g., object detection, environment mapping, localization, etc.) on BEV features 612 and generate output 616 as a result. Output 616 may include a list of predictions. Each prediction may include an anchor point and an offset relative to the anchor point. The predictions may include additional attributes, such as a class of detected object and/or orientation information regarding the object.

Tensor parser 618 may parse output 616 to generate output 620. Tensor parser 618 may translate the indices in the network output tensor to corresponding output coordinates. Since this is relative to the positional anchors, tensor parser 618 may use information regarding how the positional anchors are distributed.

In some aspects, tensor parser 618 may access anchor-coordinate data stored in memory to translate each output index to a corresponding anchor coordinate. For example, the anchor-coordinate data may include a lookup table that maps each output-index tuple (e.g., i, j) to an anchor-point coordinate (e.g., xanchor, yanchor, and/or zanchor). Tensor parser 618 may decode an offset and combine the decoded offset with the anchor-point coordinate to determine an offset-point coordinate in a modeled output area.

Comparing system 600 to system 500, architecturally, the differences include the format of output 616 is different from the format of output 516. For example, output 516 may include a grid-based tensor. For example, two dimensions of output 516 may align with two dimensions of a BEV grid. Information in a channels dimensions of output 516 may provide attribute data regarding a cell of the BEV grid. In contrast, output 616 may be, or may include, a list of predictions, each prediction including an anchor point and an offset relative to the anchor point. The predictions may include additional attributes.

Additionally, comparing system 600 to system 500, an algorithm to parse output tensor (e.g., of tensor parser 618) is changed. The output parsing of tensor parser 618 is more complicated since the correspondence between output index and anchor coordinates is no longer trivial. Additionally, quantization ranges are chosen differently. For example, quantization ranges are chosen with respect to the new, longer distances.

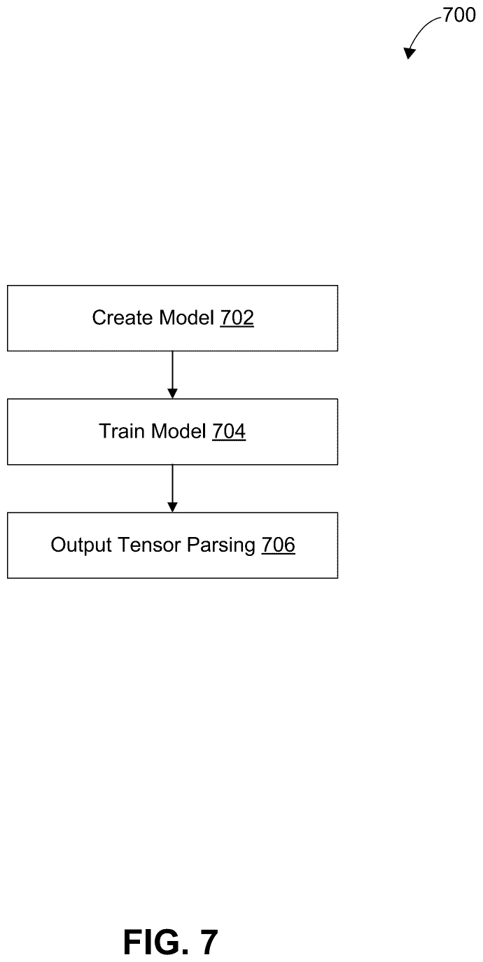

FIG. 7 is a flow diagram illustrating an example process 700 for preparing a model to perform BEV perception tasks, according to various aspects of the present disclosure. For example, process 700 may be used to generate BEV perception task 614 and/or tensor parser 618 of FIG. 6. For various steps of process 700, a comparison is provided relative to a process of generating a grid-based BEV perception task (e.g., grid-based BEV perception task 514 of FIG. 5).

At block 702, a model may be created. To generate a model to perform grid-based BEV perception task (e.g., grid-based BEV perception task 514), each output grid cell corresponds to a square partition of the XY plane around the ego platform. Thus each grid cell has an area, and adjacent grid cells cover adjacent squares in the world, with no overlap. Outputs are contained in grid cells, and only one output can be represented by each grid cell. Quantization ranges are chosen such that outputs can represent coordinates inside the square.

In contrast, to generate a model to perform a BEV perception task according to various aspects of the present disclosure (e.g., BEV perception task 614), output tensor channels are modelled differently than the output tensor channels are modeled when generating a model to perform a grid-based BEV perception task. To generate a model to perform a BEV perception task according to various aspects of the present disclosure, each output point corresponds to an anchor point in the world. The mapping between anchor point and prior world coordinate can be any mapping. Additionally there may be no concept of a grid or area. The predictions can move to any coordinate in the world, with the anchor acting only as a prior position. Quantization ranges are chosen such that outputs can represent coordinates anywhere within the modelled XY plane.

The following examples relates to a grid-based BEV perception task. For example, 50 meters of detection distance all around an ego platform (e.g., 100 meters back and forth) may be modeled. A grid-based BEV perception task may output a 256×256 output map.

In such an example, each grid cell is assigned to cover 100/256≈40 centimeters (cm). The first output cell would correspond to the area:

x ∈[−50, −49.6], y ∈[50, 49.6]
The second output cell would correspond to an area:

x ∈[−49.6, −49.2], y ∈[50, 49.6]
etc.

The quantization ranges would be chosen to be:

x_{quant}=[−0.20, 0.20], y_{quant}=[−0.20, 0.20]
for the x and y output channels since this describes all the positions available inside each square.

When reading this output, no prediction can express a coordinate outside of their corresponding square.

In contrast, to model 50 meters of detection distance all around an ego platform according to various aspects of the present disclosure, the systems and techniques may instead use an output of size 64×64. The systems and techniques may use a smaller number of outputs because the systems and techniques may represent the detections with fewer predictions because the systems and techniques do not output cells devoid of predictions. Outputting predictions using smaller data structures is less computationally expensive.

For simplicities'sake, the anchor positions (spatial priors) may be uniformly distributed. The anchor points may thus be distributed with the distance:

100/64≈1.6 m
such that the first output cell will correspond to the coordinate,

x=50, y=50
the second one,

x=48.4, y=50
etc.

The quantization ranges are then chosen based on the problem at hand, but could for example be:

x_{quant}=[−10, 10], y_{quant}=[−10, 10]
allowing the first prediction to output a coordinate somewhere between

x_{range}=[40, 60], y_{range}=[40, 60]
and the second output prediction can output a coordinate somewhere between

x_{range}=[38.4, 58.4], y_{range}=[40, 60].

In some aspects, a quantization scheme for offsets may balance a maximum representable offset distance and a localization resolution. In some implementations, the systems and techniques may represent an offset using multiple components encoded in multiple channels. For example, a first offset component may represent a coarse displacement selected from a coarse quantization range, while a second offset component may represent a residual displacement selected from a finer quantization range. Tensor parser 618 may decode each component and combine the components (e.g., by summation) to reconstruct a total offset. Such a multi-component offset representation may support long-range detections while maintaining fine localization granularity.

As can be seen, adjacent output indices (e.g., predictions) have overlapping areas in which the output indices can output predictions. Allowing indices to have overlapping areas addresses the deficient-modelling problem of grid-based BEV perception task by allowing an arbitrary number of outputs to be representable in any chosen subset of the modelled space.

After creating the model for the BEV perception task at block 702, the model is trained at block 704. The model may be trained according to an iterative training process. For example, a corpus of training data may include a number of training data sets. An example training data set may include BEV features and corresponding ground-truth data. The ground-truth data may include a list of points corresponding to the task for which the model is being trained. For example, the ground-truth data may include a number of points of an environment that correspond to detected objects. The model may process the BEV features and generate a provisional output. The provisional output may be compared with the ground-truth data to determine a loss (e.g., based on differences between the provisional output and the ground-truth data). The model may be modified (e.g., parameters, such as weights, of the model may be adjusted) such that in further iterations of the training process, further provisional outputs of the model are more similar to further corresponding instances of ground-truth data.

In some aspects, the systems and techniques may construct ground-truth point lists without rasterizing annotations into grid cells. For example, for a lane-marking detection task, the systems and techniques may obtain an annotated lane polyline in an ego-centric coordinate system and sample points along the polyline at substantially equidistant arc-length intervals to generate lane-sample points. For an object-detection task, the systems and techniques may represent an annotated object using one or more representative points, such as an object center, one or more bounding-box corners, and/or a set of surface points. The systems and techniques may use a ground-truth point list as a target for distance-based matching to predictions generated relative to anchor points.

To compare the provisional outputs to the ground-truth data, the systems and techniques may minimize the maximum distance between output points and ground-truth points. For example, the systems and techniques may sum the distance from each ground-truth point to a nearest output point. The systems and techniques may determine the loss based on the summed distance and modify the model to decrease the loss in further iterations of the training process.

In some aspects, systems and techniques may train the model using the distance-based loss in conjunction with one or more additional loss terms. Example additional loss terms may include an existence-confidence loss, a classification loss, an attribute-regression loss for offsets and/or other attributes, an offset-magnitude regularization loss that penalizes excessively large offsets, and/or a smoothness loss that encourages continuity among predicted points associated with a same instance. Systems and techniques may weight loss terms to improve convergence and/or to reduce false positives.

In addition to generating the model (e.g., BEV perception task 614), at block 706, process 700 may generate a parser to parse outputs of the model (e.g., tensor parser 618). A grid-based parser (e.g., tensor parser 518), output a prediction for each output channel with an estimated existence over a threshold. X and Y channels are read and their relative magnitudes compared to the chosen quantization range. The parser may place the output predictions in the area designated to each specific grid cell.

In contrast, a parser according to various aspects of the present disclosure (e.g., tensor parser 618) may output a prediction for each output channel with an estimated existence over a threshold. X and Y channels are read and their relative magnitude compared to the new quantization ranges. The parser may place the preselected position anchors according to the prediction coordinates anywhere in the modelled output area.

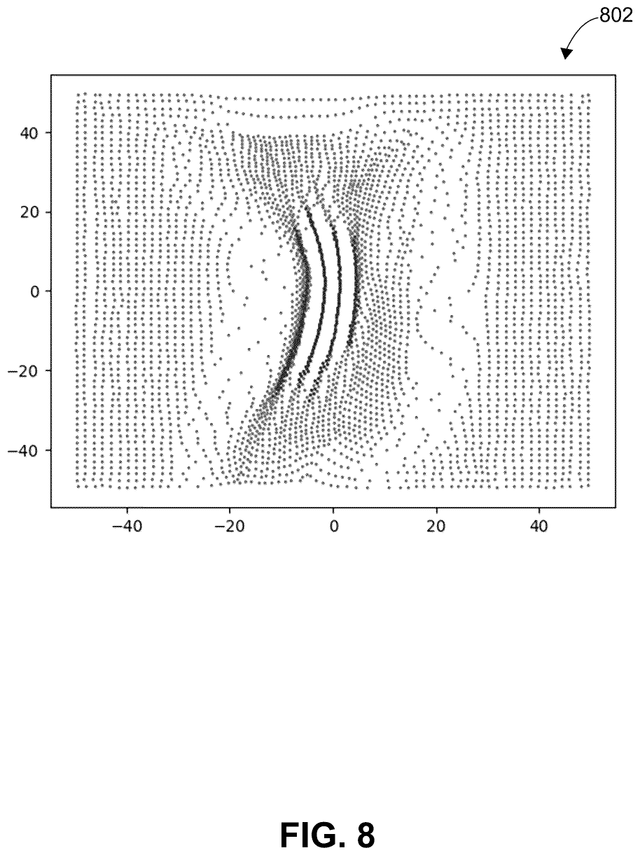

FIG. 8 is a diagram including an example representations of output arrangements 802 according to various aspects of the present disclosure. Output arrangement 802 is an example of an output of a trained network, (e.g., output 616). The dark dots in output arrangement 802 are thresholded on existence confidence, representing the actual output passed onto downstream tasks. As can be seen in FIG. 8, the anchors are pulled to the areas of interest.

As there is no cell assignment, any required number of anchors can be used by the model to represent any dense set of instances, this means, model can easily and inherently handle any dense scenario (e.g., groups of pedestrians, close vehicles, close road and lane markings, etc.).

As there is no grid, the systems and techniques do not need to worry about the resolution. Hence there is no need for complicated grid designs (no need for logarithmic, polar, etc.).

As there is no grid and anchors can move freely, the model learns the optimal distributions of the anchor points. Additionally, there are no rasterization artifacts.

The systems and techniques can efficiently express outputs (e.g., reducing a 256×256 grid around the car to just 64×64 anchors). Such a reduction makes the systems and techniques less computationally expensive than grid-based BEV perception tasks. Additionally, the output is independent of range to scale.

The systems and techniques address the fundamental issues of grid-based BEV perception tasks. For example, the systems and techniques are seamlessly applicable to any sensor modality (e.g., camera, RADAR, and/or LIDAR).

Detectors, according to various aspects of the present disclosure, may perform better with respect to statistical metrics than classical grid-based methods. As examples, a lane detector, according to various aspects of the present disclosure, may have a higher F1 score than a grid-based lane detector. Additionally an object detector according to various aspects of the present disclosure may have a higher mean average precision (mAP) and/or freespace detection than a grid-based object detector. Additionally or alternatively, in a multitask scenario, the systems and techniques may change the Lane and Freespace functions to produce a 64×64 output while keeping vehicle and pedestrian detection tasks at a 256×256 output resolution, enabling flexibility in a multitask setting.

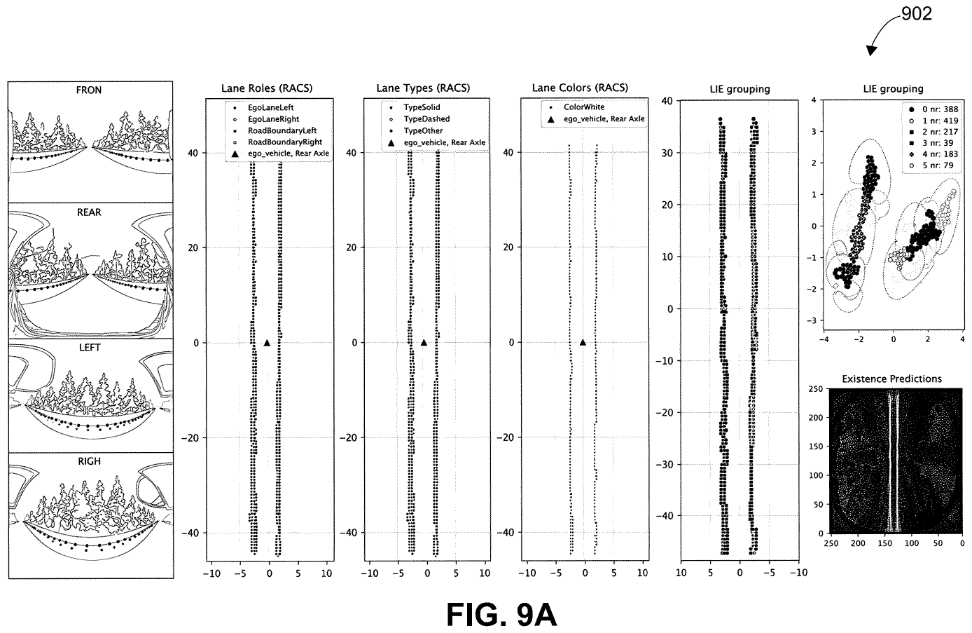

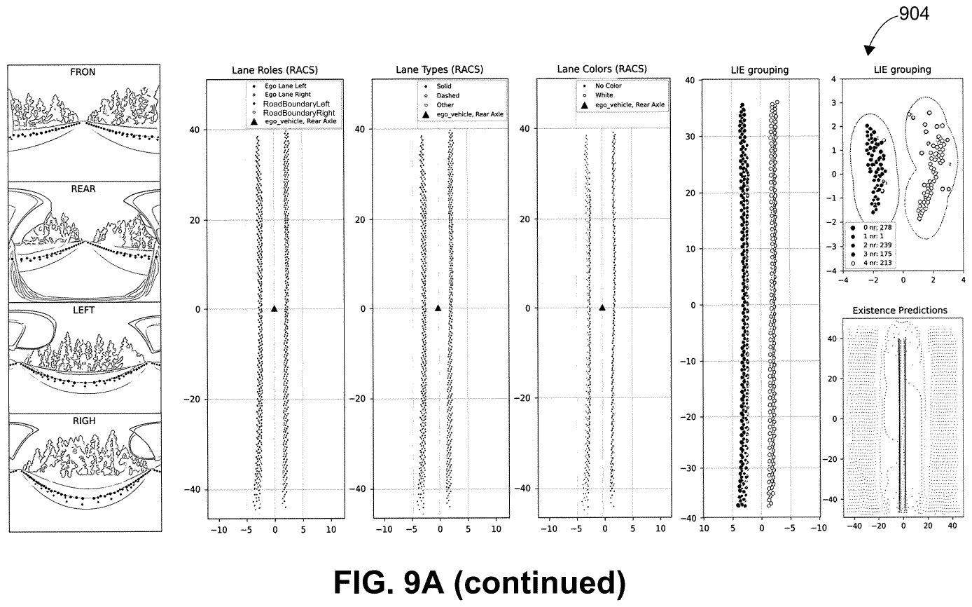

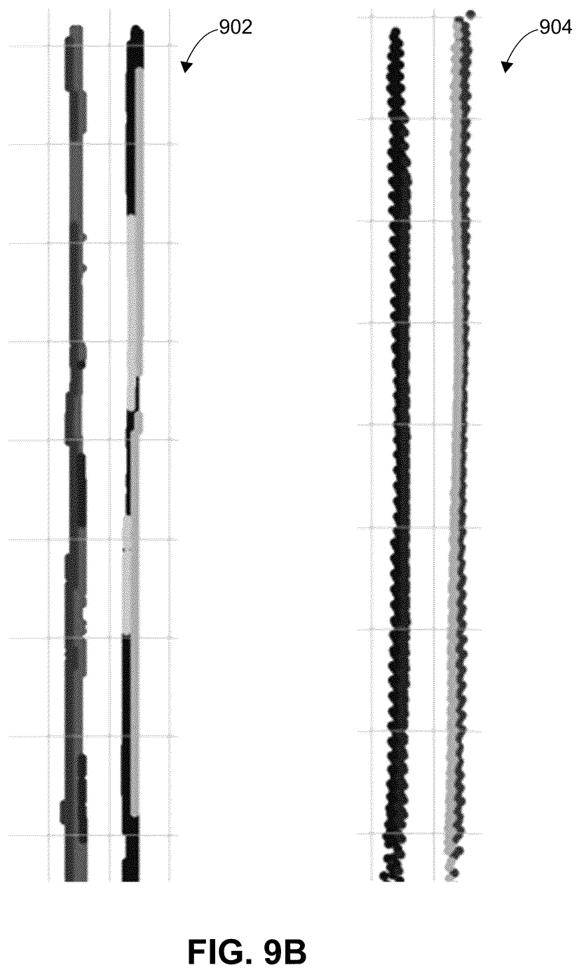

FIG. 9A and FIG. 9B include representations of detection outputs 902 of a grid-based BEV lane-detection task and a representation of detection outputs 904 of a lane-detection task according to various aspects of the present disclosure. As can be seen, detection outputs 904 are smoother than detection outputs 902. For example, outputs 904 includes fewer double-detections and less jittery behavior than detection outputs 902. In FIG. 9B, consequences of the rasterization artifacts are noticeable.

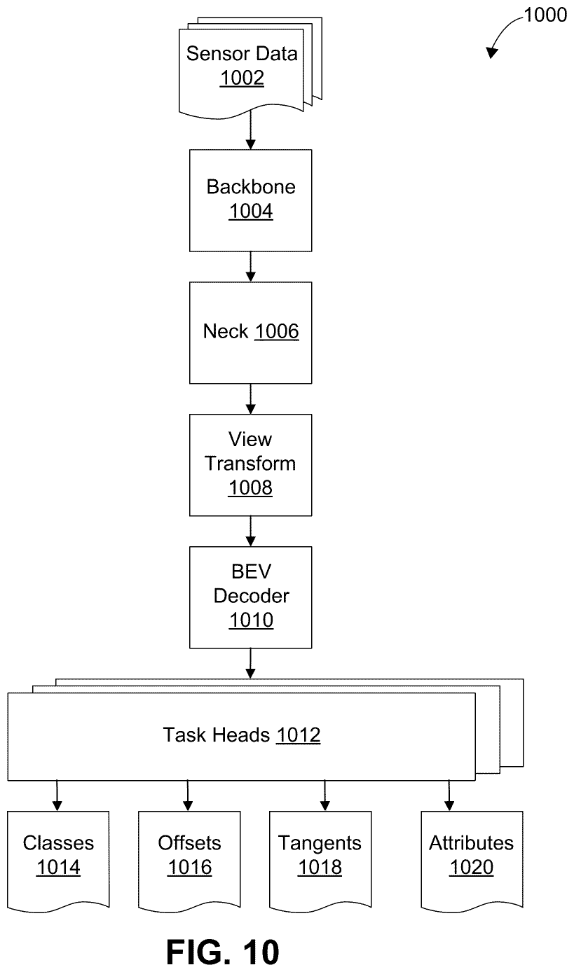

FIG. 10 is a block diagram illustrating an example system 1000 that may perform a perception task, according to various aspects of the present disclosure. For example, backbone 1004, neck 1006, and view transform 1008 may generate BEV features based on sensor data 1002. BEV decoder 1010 and task heads 1012 may process the BEV features to perform one or more perception tasks.

Sensor data 1002 may include data from a sensor, such as image data, LIDAR data, and/or RADAR data. Backbone 1004 may encode sensor data 1002 to generate features. Neck 1006 may process the features. View transform 1008 may project the features into a BEV space. BEV decoder 1010 may decode the BEV features. BEV decoder 1010 may operate in conjunction with task heads 1012 to perform a task.

Task heads 1012 may perform one or more tasks, such as, object detection (e.g., pedestrian detection, lane detection, vehicle detection, etc.), environmental mapping, localization, etc. Task heads 1012 may output various outputs, such as, classes 1014, offsets 1016, tangents 1018 and/or other attributes (not illustrated in FIG. 10).

Classes 1014 may be, or may include, classes of objects detected. For example, classes 1014 may include an indication of whether predictions output by task heads 1012 include pedestrians, vehicles, lane lines, lane boundaries, road edges, crosswalks, traffic signs, traffic lights, etc.

Offsets 1016 may indicate an offset between an anchor point and a predicted position. For example, an anchor point may have coordinates (relative to an ego vehicle) indicting that the anchor point is 5 meters directly in front of the vehicle. Task heads 1012 may detect something 4 meters ahead of the vehicle and “move” the anchor point one meter closer to the vehicle. For example, task heads 1012 may generate a prediction including the anchor point (having coordinates 5 meters in front of the vehicle) and the offset (indicating an offset 1 meter closer to the vehicle).

Tangents 1018 may be, or may include, a secondary characteristic in a lane detection head. Tangents 1018 may be used to predict which direction each detected point is aligned in (e.g., which direction is the tangent of the point as a part of a lane marking). Tangents may be one of many attributes that can be detected by a lane head.

Attributes 1020 may be, or may include, characteristics of the predictions output by task heads 1012. Examples of attributes 1020 include height, width, length, yaw, pitch, roll, velocity, class, etc.

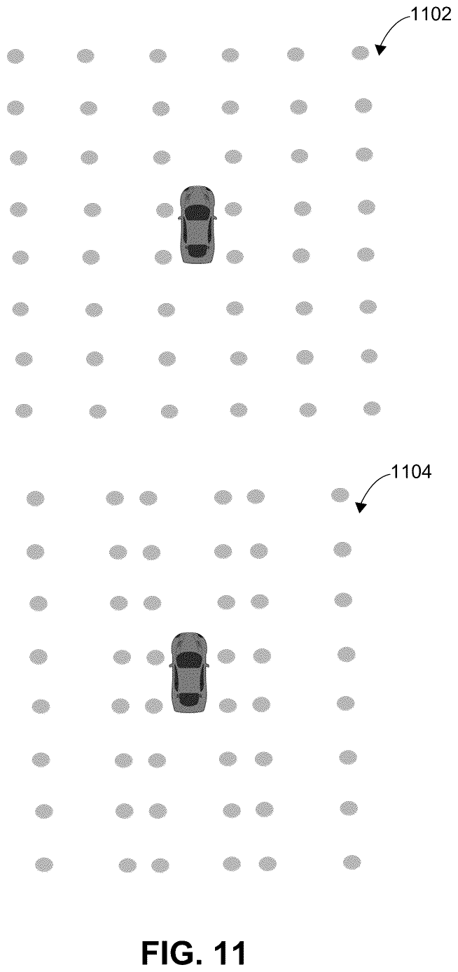

According to various aspects of the present disclosure, anchor points may be uniformly distributed. For example, FIG. 11 includes a representation of uniformly-distributed anchor-point distribution 1102. For instance, a simple way to distribute point anchors is a uniform distribution of point anchors. With a uniform distribution, there is no bias towards any specific area.

Alternatively, according to various aspects of the present disclosure, anchor points may be non-uniformly distributed. For example, FIG. 11 includes a representation of non-uniformly distributed anchor-point distribution 1104, according to various aspects of the present disclosure. The distribution of anchor-point distribution 1104 may be based on a task which may process predictions generated based on anchor-point distribution 1104. For example, for lane detections, anchor points of anchor-point distribution 1104 may be distributed according to expected locations of lane lines relative to a center of anchor-point distribution 1104 (e.g., relative to an ego platform).

For example, from domain knowledge, it may be assumed that objects to be detected (e.g., lanes lines) are more common close to an ego platform. The point anchors may be distributed to reflect this assumption, while still keeping some anchors farther away from the ego platform to cover the less regular cases. As long as the new distribution of point anchors is a continuous transformation from a uniform grid, the distribution preserves the relative location of the anchors, thus preserving information locality, an important strength of CNNs.

For instance, training data could be analyzed to find a heat map over where predictions are most common. The point anchors could be distributed to reflect to this distribution.

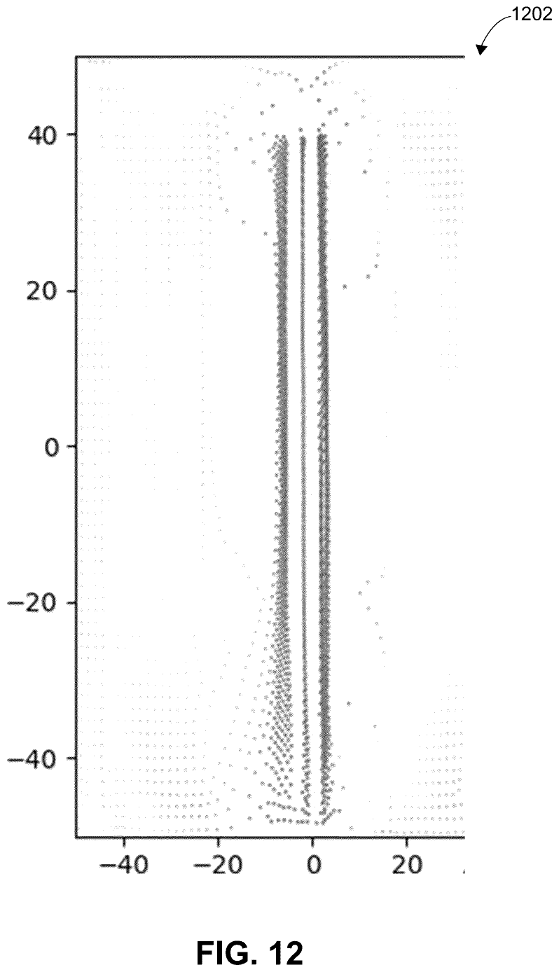

For instance, if detections are to reach 150 meters in front, but just 40 meters in the other directions, the spatial priors (e.g., the point anchors) may be modified to reflect this. For example, FIG. 12 includes a representation of an example anchor-point distribution 1202, according to various aspects of the present disclosure.

The point anchors can be chosen on a per-task basis. So lane detection and vehicle detection could for example use different point anchors to leverage farther detection distance for vehicle detection without affecting lane detection.

In some aspects, an anchor-point distribution may be selected during model design and stored to be used as configuration data for inference. For example, training data, inference logs, simulation logs, and/or field-reported failure cases may be analyzed to identify one or more BEV regions that may benefit from higher anchor density. An updated anchor-point distribution may be generated based on the analysis. The updated anchor-point distribution may be deployed with a trained model. During inference, anchor points may remain fixed for a given model instance, while predictions may shift via offsets relative to the fixed anchor points.

In some aspects, multiple tasks may share a common anchor-point distribution. For example, a single task head may output predictions that each include an object-class attribute indicating whether a prediction corresponds to a lane-marking class, a vehicle class, a pedestrian class, and/or another class. Additionally or alternatively, multiple task heads may each output predictions relative to a same anchor-point distribution. Sharing anchor points may reduce memory overhead and may simplify parsing.

In some aspects, the systems and techniques may, additionally or alternatively, provide instance information. For example, the systems and techniques may implement embedding-based approach and/or an anchor-based approach to instance detection.

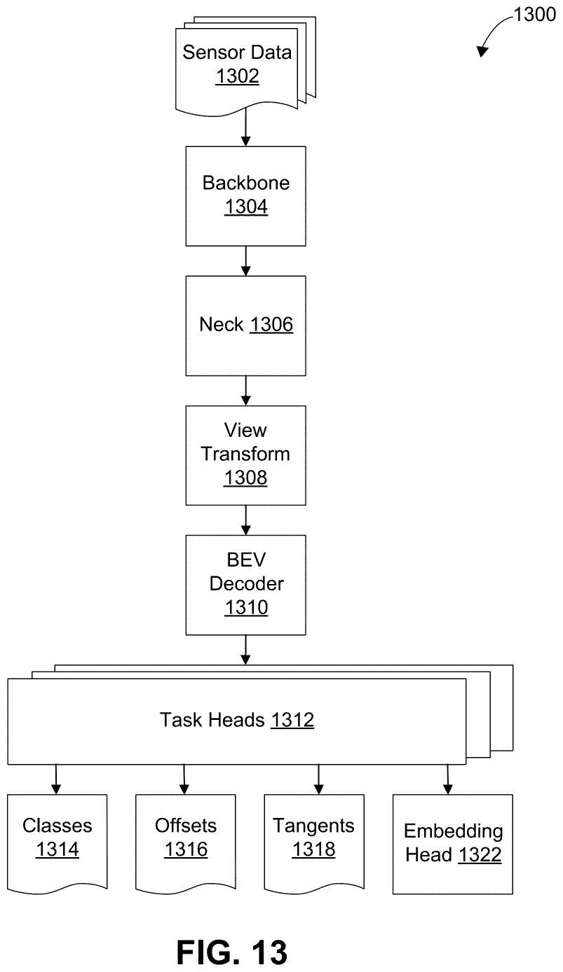

FIG. 13 is a block diagram illustrating an example system 1300 that may perform a perception task and provide instance information, according to various aspects of the present disclosure. For example, system 1300 may implement embedding-based, grid-free perception instance detection.

System 1300 is similar to system 1000. Sensor data 1302 may be the same as, or may be substantially similar to, sensor data 1002. Backbone 1304 may be the same as, may be substantially similar to, and/or may perform the same, or substantially the same, operations as backbone 1004. neck 1306 may be the same as, may be substantially similar to, and/or may perform the same, or substantially the same, operations as neck 1006. View transform 1308 may be the same as, may be substantially similar to, and/or may perform the same, or substantially the same, operations as view transform 1008. BEV decoder 1310 may be the same as, may be substantially similar to, and/or may perform the same, or substantially the same, operations as BEV decoder 1010. Task heads 1312 may be the same as, may be substantially similar to, and/or may perform the same, or substantially the same, operations as task heads 1012. Classes 1314 may be the same as, or may be substantially similar to, classes 1014. Offsets 1316 may be the same as, or may be substantially similar to, offsets 1016. Tangents 1318 may be the same as, or may be substantially similar to, tangents 1018. Although not illustrated in FIG. 13, task heads 1312 may output various other attributes (such as attributes 1020).

Embedding head 1322 may generate instance information for predictions of task heads 1312. For example, for each task/head of task heads 1312, embedding head 1322 may include a respective embedding head. Each embedding head of task heads 1312 may map each of the anchor points into an embedding space. The anchor points may be mapped such that: anchor points coming from the same instance are close to each other (in the embedding space), anchor points coming from different instances are far apart (in the embedding space), and anchor points that are not assigned to any instance should be distant from anchor points that are assigned to instances (such anchor points may be mapped to an origin).

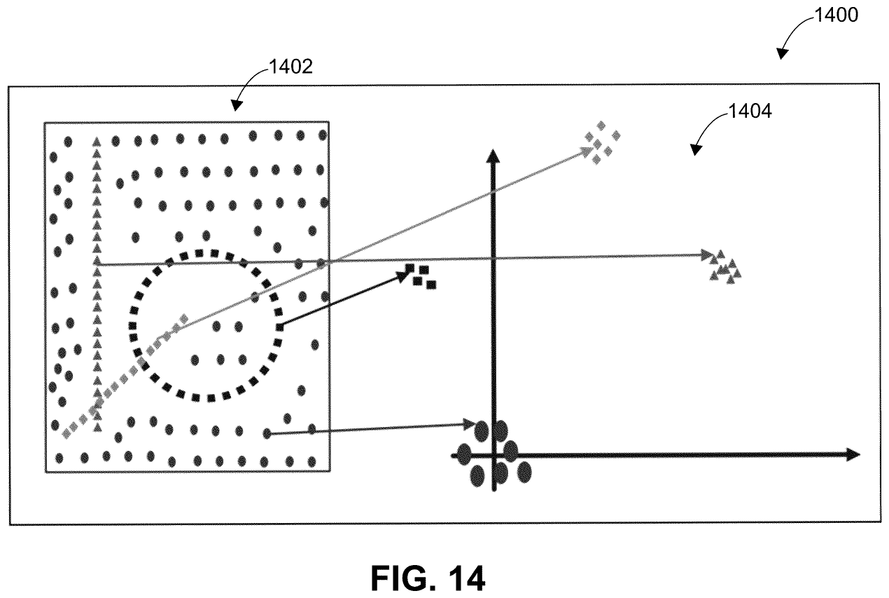

For example, FIG. 14 includes a representation 1400 of an example BEV space 1402 and a related example embedding space 1404, according to various aspects of the present disclosure. BEV space 1402 and embedding space 1404 are represented in two dimensions for simplicity. BEV space 1402 may be a 3D space and embedding space 1404 may have any number of dimensions.

Various shapes in representation 1400 represent common instances. For example, the triangles in representation 1400 may represent a first instance while the squares may represent a second instance and diamonds may represent a third instance. The remainder of anchor points (illustrated as circles) are not assigned to any instance. An embedding head (e.g., embedding head 1322) may project anchor points of BEV space 1402 into embedding space 1404. In embedding space 1404, triangles are close to other triangles. Squares are close to other squares but distant from the triangles. Diamonds are close to diamonds but distant from the triangles and the squares.

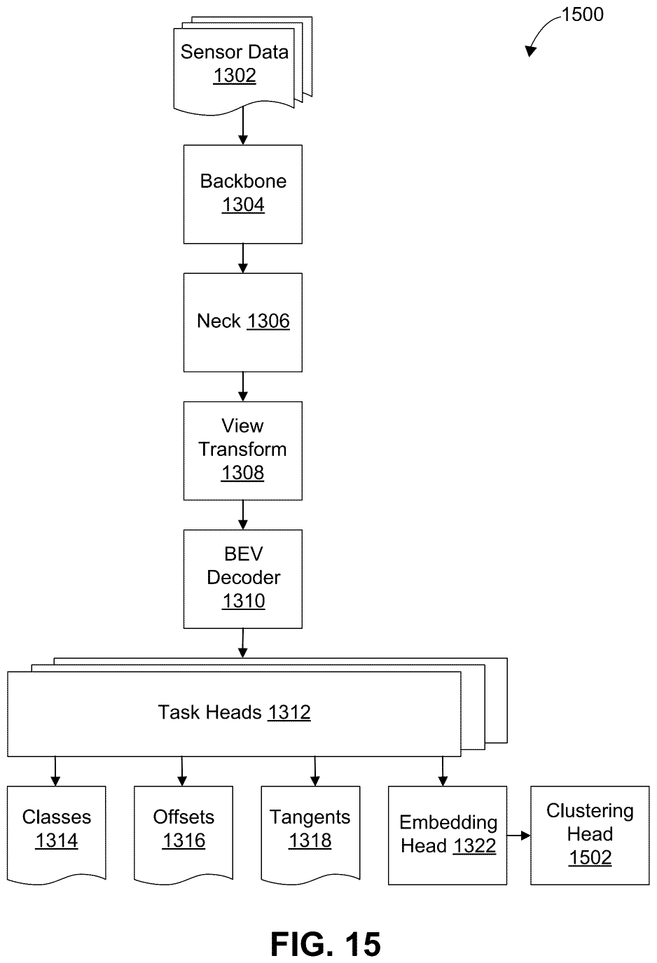

FIG. 15 is a block diagram illustrating an example system 1300 that may perform a perception task and provide instance information, according to various aspects of the present disclosure. For example, system 1500 may implement embedding-based, grid-free perception instance detection.

System 1500 may include system 1300. Additionally, clustering head 1502 may perform post processing (e.g., clustering). For example, clustering head 1502 may apply a cluster-detection head on top of the embeddings so that the cluster-detection head predicts the instance clusters. Clustering head 1502 may find instances by comparing their distance to these clusters. Clustering head 1502 may set a fixed large number of clusters. As the number of instances at each scene is less than clusters, some clusters will be assigned to background. Clustering head 1502 may be trained such that clustering head 1502 can use approaches like Hungarian matching for the assignments.

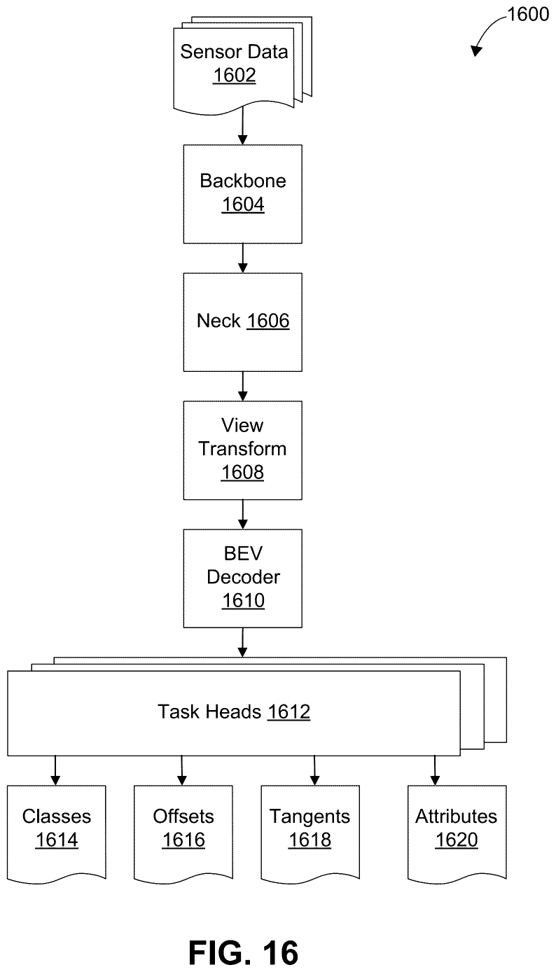

FIG. 16 is a block diagram illustrating an example system 1600 that may perform a perception task and provide instance information, according to various aspects of the present disclosure. For example, system 1600 may implement an anchor-based approach to instance detection. System 1600 may be substantially the same as system 1000.

System 1600 is similar to system 1000. Sensor data 1602 may be the same as, or may be substantially similar to, sensor data 1002. Backbone 1604 may be the same as, may be substantially similar to, and/or may perform the same, or substantially the same, operations as backbone 1004. neck 1606 may be the same as, may be substantially similar to, and/or may perform the same, or substantially the same, operations as neck 1006. View transform 1608 may be the same as, may be substantially similar to, and/or may perform the same, or substantially the same, operations as view transform 1008. BEV decoder 1610 may be the same as, may be substantially similar to, and/or may perform the same, or substantially the same, operations as BEV decoder 1010. Task heads 1612 may be the same as, may be substantially similar to, and/or may perform the same, or substantially the same, operations as task heads 1012. Classes 1614 may be the same as, or may be substantially similar to, classes 1014. Offsets 1616 may be the same as, or may be substantially similar to, offsets 1016. Tangents 1618 may be the same as, or may be substantially similar to, tangents 1018. Attributes 1620 may be the same as, or may be substantially similar to, attributes 1020. Although not illustrated in FIG. 16, task heads 1612 may output various other attributes (such as attributes 1020).

Additionally, according to an anchor-based approach to instance detection, system 1600 may extend the point anchors to instance anchors. For example, instead of having one point anchor, task heads 1612 may generate a group of points (e.g., 10 points) that they form an anchor. Task heads 1612 may use a fixed number of such instance anchors, (e.g., 100 instance anchors). In such an example, task heads 1612 may generate 1000 anchor points (e.g., 100 instance anchors of 10 points each.

Task heads 1612 may generate a set of initial distributions for the anchor points. Anchor points can be obtained by checking the instances shapes in the training set and finding clusters of such shapes as the base anchors. The instance shapes can be defined based on known shape of instances (lines for sloid or dashed lane markings, circle for round abouts, rectangles for pedestrian crossings, etc.). Task heads 1612 may assign these anchors to the instances and then perform the training.

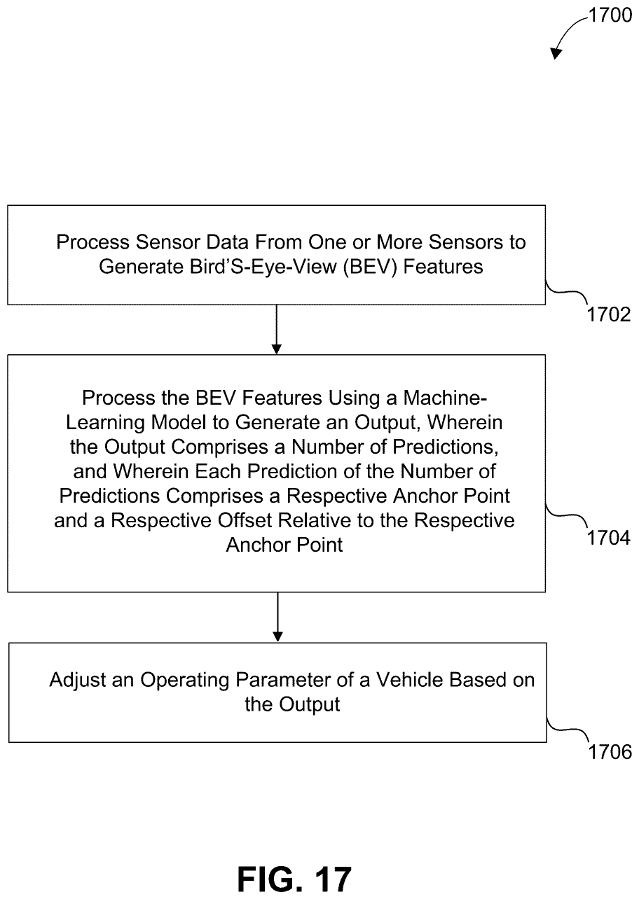

FIG. 17 is a flow diagram illustrating an example process 1700 for processing data, in accordance with aspects of the present disclosure. One or more operations of process 1700 may be performed by a computing device (or apparatus) or a component (e.g., a chipset, codec, etc.) of the computing device. The computing device may be a mobile device (e.g., a mobile phone), a network-connected wearable such as a watch, an extended reality (XR) device such as a virtual reality (VR) device or augmented reality (AR) device, a vehicle or component or system of a vehicle, a desktop computing device, a tablet computing device, a server computer, a robotic device, and/or any other computing device with the resource capabilities to perform the one or more operations of process 1700. The one or more operations of process 1700 may be implemented as software components that are executed and run on one or more processors.

At block 1702, a computing device (or one or more components thereof) may process sensor data from one or more sensors to generate bird's-eye-view (BEV) features. For example, system 600 may generate BEV features 612 (e.g., by processing sensor data 604 using encoder 606 to generate features 608 and projecting features 608 using projector 610 to generate BEV features 612).

In some aspects, the sensor data may be, or may include, at least one of: image data, radio detection and ranging (RADAR) data, or light detection and ranging (LIDAR) data. For example, sensor(s) 602 may be, or may include, a camera, a RADAR system, and/or a LIDAR system. Sensor data 604 may be, or may include, image data, RADAR data, and/or LIDAR data.

In some aspects, the sensor data may be, or may include, first image data from a first camera; and second image data from a second camera.

In some aspects, image data from a camera; and light detection and ranging (LIDAR) data from a LIDAR system.

In some aspects, wherein the sensor data may be, or may include, light detection and ranging (LIDAR) data from a LIDAR system.

In some aspects, the sensor data may be, or may include, image data from a camera; and radio detection and ranging (RADAR) data from a RADAR system.

In some aspects, the sensor data may be, or may include, radio detection and ranging (RADAR) data from a RADAR system.

In some aspects, the sensor data may be, or may include, image data from a camera; light detection and ranging (LIDAR) data from a LIDAR system; and radio detection and ranging (RADAR) data from a RADAR system.

In some aspects, the sensor data is processed using an encoder machine-learning model to generate feature data, the apparatus further comprising projecting the feature data to generate the BEV features. For example, system 600 may generate BEV features 612 by processing sensor data 604 using encoder 606 to generate features 608 and projecting features 608 using projector 610 to generate BEV features 612.

At block 1704, the computing device (or one or more components thereof) may process the BEV features using a processing head to generate an output, wherein the output may be, or may include, a number of predictions, and wherein each prediction of the number of predictions may be, or may include, a respective anchor point and a respective offset relative to the respective anchor point. For example, BEV perception task 614 may process BEV features 612 to generate output 616. Output 616 may be, or may include, a number of predictions. Each of the predictions may be, or may include, an anchor point and an offset. For example, output 616 may be made up of offset points 314, which may be anchor points, offset. In some aspects, the processing head may be, or may include, a machine-learning model trained to process BEV features to perform a task. For example, BEV perception task 614 may be, or may include, a machine-learning model trained to perform a task. In some aspects, the output 616 may be made up of offset points 314, which may be anchor points, offset.

In some aspects, the number of predictions are generated such that the respective offset of each prediction of the number of predictions is within a distance limit of the respective anchor point associated with the prediction. For example, each of offset points 314 may be offset from anchor points 304. Each of offset points 314 may be offset by less than a distance limit from a corresponding one of anchor points 304.

In some aspects, the distance limit is greater than a mean distance between neighboring anchor points of the number of predictions. For example, the distance limit between offset points 314 and their corresponding anchor points 304 may be less than a mean distance between neighboring anchor points 304.

In some aspects, the anchor points of the number of predictions are uniformly distributed. For example, the anchor points may be uniformly distributed, such as uniformly-distributed anchor-point distribution 1102 of FIG. 11.

In some aspects, the anchor points are unevenly distributed based on a task related to the machine-learning model. For example, the anchor points may be unevenly distributed, such as anchor-point distribution 1104 of FIG. 11.

In some aspects, each prediction of the number of predictions may be, or may include, a class attribute indicative of an object represented by the prediction. For example, each of offset points 314 may have a class attribute.

In some aspects, the machine-learning model is trained to detect one or more classes of objects; wherein each prediction of the number of predictions is indicative of detected object. For example, BEV perception task 614 may be configured to detect one or more classes of objects. In such cases, the predictions (e.g., of block 1704) may be indicative of classes detected.

In some aspects, the computing device (or one or more components thereof) may be, or may include, a computing system of a vehicle.

At block 1706, the computing device (or one or more components thereof) may adjust an operating parameter of the vehicle based on the output.

In some aspects, the operating parameter is associated with at least one of a path for the vehicle to travel, a steering parameter for operating steering of the vehicle, a braking parameter for operating brakes of the vehicle, a lane-change parameter for causing the vehicle to navigate from a first lane to a second lane, or displaying information related to the output using a user interface of the vehicle.

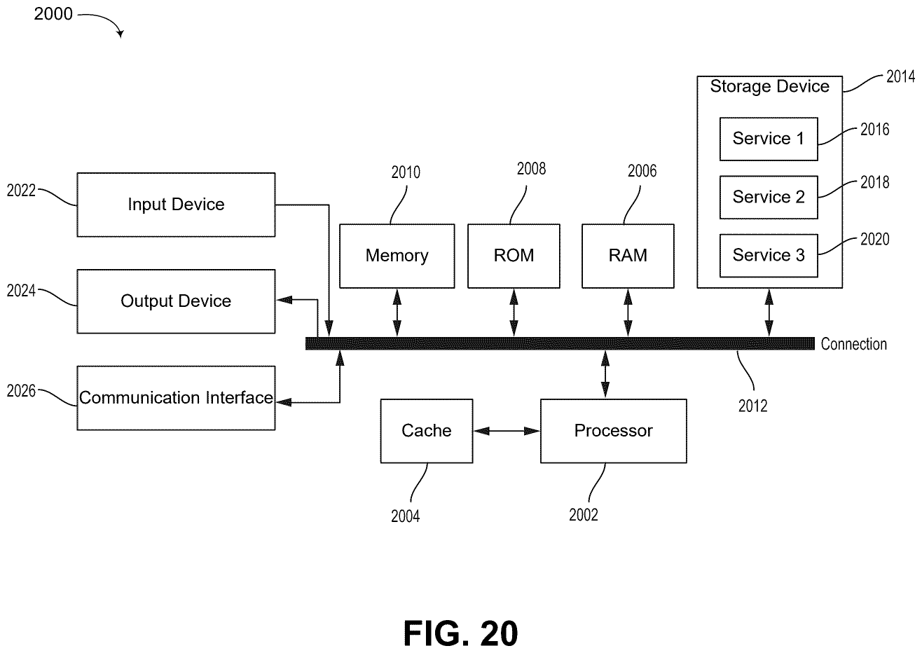

In some examples, as noted previously, the methods described herein (e.g., process 700 of FIG. 7, process 1700 of FIG. 17, and/or other methods described herein) can be performed, in whole or in part, by a computing device or apparatus. In one example, one or more of the methods can be performed by system 600 of FIG. 6, system 1000 of FIG. 10, system 1300 of FIG. 13, system 1500 of FIG. 15, system 1600 of FIG. 16, or by another system or device. In another example, one or more of the methods (e.g., process 1700, and/or other methods described herein) can be performed, in whole or in part, by the computing-device architecture 2000 shown in FIG. 20. For instance, a computing device with the computing-device architecture 2000 shown in FIG. 20 can include, or be included in, the components of the system 600, system 1000, system 1300, system 1500, system 1600, and can implement the operations of process 700, process 1700, and/or other process described herein. In some cases, the computing device or apparatus can include various components, such as one or more input devices, one or more output devices, one or more processors, one or more microprocessors, one or more microcomputers, one or more cameras, one or more sensors, and/or other component(s) that are configured to carry out the steps of processes described herein. In some examples, the computing device can include a display, a network interface configured to communicate and/or receive the data, any combination thereof, and/or other component(s). The network interface can be configured to communicate and/or receive Internet Protocol (IP) based data or other type of data.

The components of the computing device can be implemented in circuitry. For example, the components can include and/or can be implemented using electronic circuits or other electronic hardware, which can include one or more programmable electronic circuits (e.g., microprocessors, graphics processing units (GPUs), digital signal processors (DSPs), central processing units (CPUs), and/or other suitable electronic circuits), and/or can include and/or be implemented using computer software, firmware, or any combination thereof, to perform the various operations described herein.

Process 700, process 1700, and/or other process described herein are illustrated as logical flow diagrams, the operation of which represents a sequence of operations that can be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be combined in any order and/or in parallel to implement the processes.

Additionally, process 700, process 1700, and/or other process described herein can be performed under the control of one or more computer systems configured with executable instructions and can be implemented as code (e.g., executable instructions, one or more computer programs, or one or more applications) executing collectively on one or more processors, by hardware, or combinations thereof. As noted above, the code can be stored on a computer-readable or machine-readable storage medium, for example, in the form of a computer program comprising a plurality of instructions executable by one or more processors. The computer-readable or machine-readable storage medium can be non-transitory.

As noted above, various aspects of the present disclosure can use machine-learning models or systems.

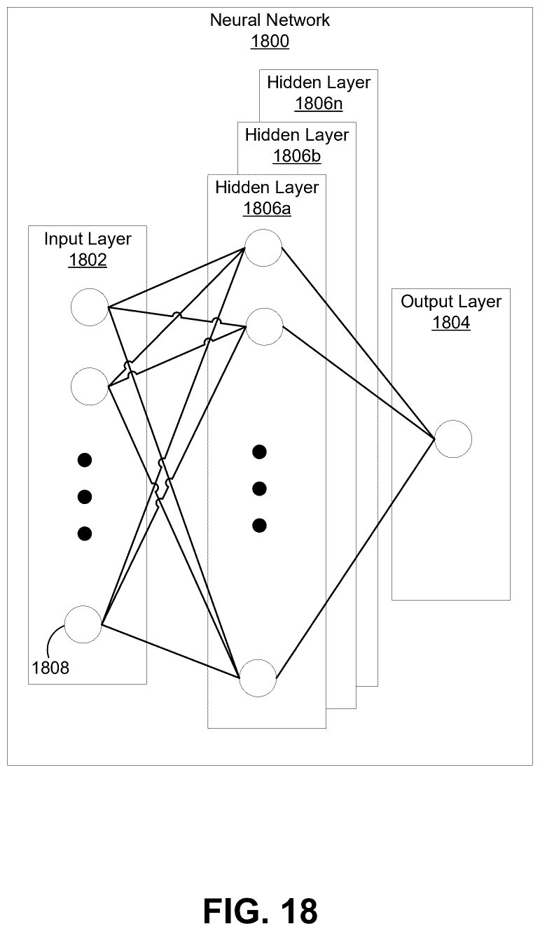

FIG. 18 is an illustrative example of a neural network 1800 (e.g., a deep-learning neural network) that can be used to implement machine-learning based feature segmentation, implicit-neural-representation generation, rendering, classification, object detection, image recognition (e.g., face recognition, object recognition, scene recognition, etc.), feature extraction, authentication, gaze detection, gaze prediction, and/or automation. For example, neural network 1800 may be an example of, or can implement, encoder 606 and/or BEV perception task 614 of FIG. 6, backbone 1004, neck 1006, view transform 1008, BEV decoder 1010, and/or task heads 1012 of FIG. 10, backbone 1304, neck 1306, view transform 1308, BEV decoder 1310, task heads 1312, embedding head 1322, and/or clustering head 1502 of FIG. 13 and/or FIG. 15, backbone 1604, neck 1606, view transform 1608, BEV decoder 1610, and/or task heads 1612 of FIG. 16.

An input layer 1802 includes input data. In one illustrative example, input layer 1802 can include data such as text data, numerical data, image data, audio data, video data, etc. Neural network 1800 includes multiple hidden layers, for example, hidden layers 1806a, 1806b, through 1806n. The hidden layers 1806a, 1806b, through hidden layer 1806n include “n” number of hidden layers, where “n” is an integer greater than or equal to one. The number of hidden layers can be made to include as many layers as needed for the given application. Neural network 1800 further includes an output layer 1804 that provides an output resulting from the processing performed by the hidden layers 1806a, 1806b, through 1806n. In one illustrative example, output layer 1804 can output data such as text data, numerical data, image data, audio data, video data, etc.

Neural network 1800 may be, or may include, a multi-layer neural network of interconnected nodes. Each node can represent a piece of information. Information associated with the nodes is shared among the different layers and each layer retains information as information is processed. In some cases, neural network 1800 can include a feed-forward network, in which case there are no feedback connections where outputs of the network are fed back into itself. In some cases, neural network 1800 can include a recurrent neural network, which can have loops that allow information to be carried across nodes while reading in input.

Information can be exchanged between nodes through node-to-node interconnections between the various layers. Nodes of input layer 1802 can activate a set of nodes in the first hidden layer 1806a. For example, as shown, each of the input nodes of input layer 1802 is connected to each of the nodes of the first hidden layer 1806a. The nodes of first hidden layer 1806a can transform the information of each input node by applying activation functions to the input node information. The information derived from the transformation can then be passed to and can activate the nodes of the next hidden layer 1806b, which can perform their own designated functions. Example functions include convolutional, up-sampling, data transformation, and/or any other suitable functions. The output of the hidden layer 1806b can then activate nodes of the next hidden layer, and so on. The output of the last hidden layer 1806n can activate one or more nodes of the output layer 1804, at which an output is provided. In some cases, while nodes (e.g., node 1808) in neural network 1800 are shown as having multiple output lines, a node has a single output and all lines shown as being output from a node represent the same output value.

In some cases, each node or interconnection between nodes can have a weight that is a set of parameters derived from the training of neural network 1800. Once neural network 1800 is trained, it can be referred to as a trained neural network, which can be used to perform one or more operations. For example, an interconnection between nodes can represent a piece of information learned about the interconnected nodes. The interconnection can have a tunable numeric weight that can be tuned (e.g., based on a training dataset), allowing neural network 1800 to be adaptive to inputs and able to learn as more and more data is processed.

Neural network 1800 may be pre-trained to process the features from the data in the input layer 1802 using the different hidden layers 1806a, 1806b, through 1806n in order to provide the output through the output layer 1804. In an example in which neural network 1800 is used to identify features in images, neural network 1800 can be trained using training data that includes both images and labels, as described above. For instance, training images can be input into the network, with each training image having a label indicating the features in the images (for the feature-segmentation machine-learning system) or a label indicating classes of an activity in each image. In one example using object classification for illustrative purposes, a training image can include an image of a number 2, in which case the label for the image can be [0 0 1 0 0 0 0 0 0 0].

In some cases, neural network 1800 can adjust the weights of the nodes using a training process called backpropagation. As noted above, a backpropagation process can include a forward pass, a loss function, a backward pass, and a weight update. The forward pass, loss function, backward pass, and parameter update are performed for one training iteration. The process can be repeated for a certain number of iterations for each set of training images until neural network 1800 is trained well enough so that the weights of the layers are accurately tuned.

For the example of identifying objects in images, the forward pass can include passing a training image through neural network 1800. The weights are initially randomized before neural network 1800 is trained. As an illustrative example, an image can include an array of numbers representing the pixels of the image. Each number in the array can include a value from 0 to 255 describing the pixel intensity at that position in the array. In one example, the array can include a 28×28×3 array of numbers with 28 rows and 28 columns of pixels and 3 color components (such as red, green, and blue, or luma and two chroma components, or the like).

As noted above, for a first training iteration for neural network 1800, the output will likely include values that do not give preference to any particular class due to the weights being randomly selected at initialization. For example, if the output is a vector with probabilities that the object includes different classes, the probability value for each of the different classes can be equal or at least very similar (e.g., for ten possible classes, each class can have a probability value of 0.1). With the initial weights, neural network 1800 is unable to determine low-level features and thus cannot make an accurate determination of what the classification of the object might be. A loss function can be used to analyze error in the output. Any suitable loss function definition can be used, such as a cross-entropy loss. Another example of a loss function includes the mean squared error (MSE), defined as Eₜₒₜₐₗ=Σ ½(target−output)². The loss can be set to be equal to the value of Eₜₒₜₐₗ.

The loss (or error) will be high for the first training images since the actual values will be much different than the predicted output. The goal of training is to minimize the amount of loss so that the predicted output is the same as the training label. Neural network 1800 can perform a backward pass by determining which inputs (weights) most contributed to the loss of the network and can adjust the weights so that the loss decreases and is eventually minimized. A derivative of the loss with respect to the weights (denoted as dL/dW, where W are the weights at a particular layer) can be computed to determine the weights that contributed most to the loss of the network. After the derivative is computed, a weight update can be performed by updating all the weights of the filters. For example, the weights can be updated so that they change in the opposite direction of the gradient. The weight update can be denoted as w=wᵢ−η dL/dW, where w denotes a weight, wᵢ denotes the initial weight, and η denotes a learning rate. The learning rate can be set to any suitable value, with a high learning rate including larger weight updates and a lower value indicating smaller weight updates.

Neural network 1800 can include any suitable deep network. One example includes a convolutional neural network (CNN), which includes an input layer and an output layer, with multiple hidden layers between the input and out layers. The hidden layers of a CNN include a series of convolutional, nonlinear, pooling (for downsampling), and fully connected layers. Neural network 1800 can include any other deep network other than a CNN, such as an autoencoder, a deep belief nets (DBNs), a Recurrent Neural Networks (RNNs), among others.

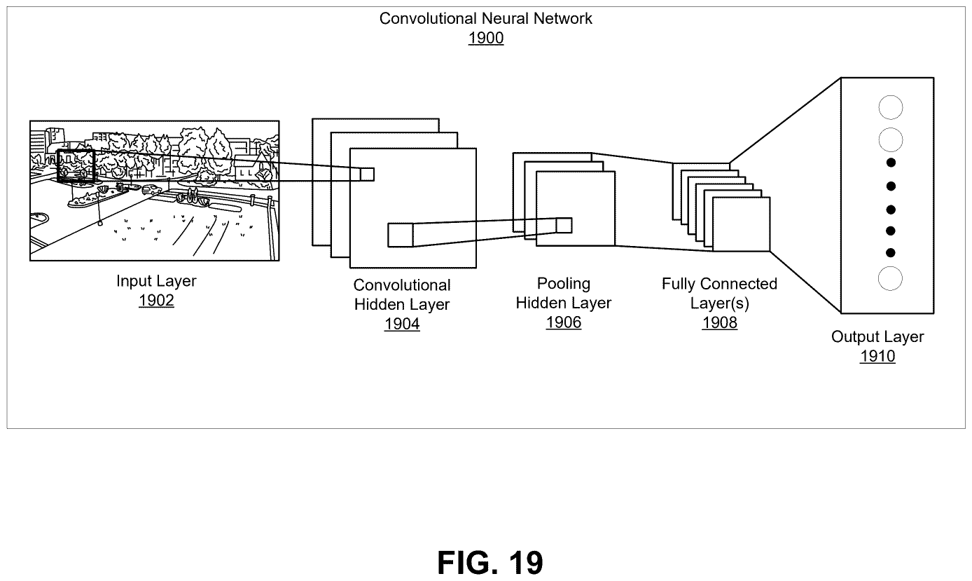

FIG. 19 is an illustrative example of a convolutional neural network (CNN) 1900. The input layer 1902 of the CNN 1900 includes data representing an image or frame. For example, the data can include an array of numbers representing the pixels of the image, with each number in the array including a value from 0 to 255 describing the pixel intensity at that position in the array. Using the previous example from above, the array can include a 28×28×3 array of numbers with 28 rows and 28 columns of pixels and 3 color components (e.g., red, green, and blue, or luma and two chroma components, or the like). The image can be passed through a convolutional hidden layer 1904, an optional non-linear activation layer, a pooling hidden layer 1906, and fully connected layer 1908 (which fully connected layer 1908 can be hidden) to get an output at the output layer 1910. While only one of each hidden layer is shown in FIG. 19, one of ordinary skill will appreciate that multiple convolutional hidden layers, non-linear layers, pooling hidden layers, and/or fully connected layers can be included in the CNN 1900. As previously described, the output can indicate a single class of an object or can include a probability of classes that best describe the object in the image.

The first layer of the CNN 1900 can be the convolutional hidden layer 1904. The convolutional hidden layer 1904 can analyze image data of the input layer 1902. Each node of the convolutional hidden layer 1904 is connected to a region of nodes (pixels) of the input image called a receptive field. The convolutional hidden layer 1904 can be considered as one or more filters (each filter corresponding to a different activation or feature map), with each convolutional iteration of a filter being a node or neuron of the convolutional hidden layer 1904. For example, the region of the input image that a filter covers at each convolutional iteration would be the receptive field for the filter. In one illustrative example, if the input image includes a 28×28 array, and each filter (and corresponding receptive field) is a 5×5 array, then there will be 24×24 nodes in the convolutional hidden layer 1904. Each connection between a node and a receptive field for that node learns a weight and, in some cases, an overall bias such that each node learns to analyze its particular local receptive field in the input image. Each node of the convolutional hidden layer 1904 will have the same weights and bias (called a shared weight and a shared bias). For example, the filter has an array of weights (numbers) and the same depth as the input. A filter will have a depth of 3 for an image frame example (according to three color components of the input image). An illustrative example size of the filter array is 5×5×3, corresponding to a size of the receptive field of a node.

The convolutional nature of the convolutional hidden layer 1904 is due to each node of the convolutional layer being applied to its corresponding receptive field. For example, a filter of the convolutional hidden layer 1904 can begin in the top-left corner of the input image array and can convolve around the input image. As noted above, each convolutional iteration of the filter can be considered a node or neuron of the convolutional hidden layer 1904. At each convolutional iteration, the values of the filter are multiplied with a corresponding number of the original pixel values of the image (e.g., the 5×5 filter array is multiplied by a 5×5 array of input pixel values at the top-left corner of the input image array). The multiplications from each convolutional iteration can be summed together to obtain a total sum for that iteration or node. The process is next continued at a next location in the input image according to the receptive field of a next node in the convolutional hidden layer 1904. For example, a filter can be moved by a step amount (referred to as a stride) to the next receptive field. The stride can be set to 1 or any other suitable amount. For example, if the stride is set to 1, the filter will be moved to the right by 1 pixel at each convolutional iteration. Processing the filter at each unique location of the input volume produces a number representing the filter results for that location, resulting in a total sum value being determined for each node of the convolutional hidden layer 1904.

The mapping from the input layer to the convolutional hidden layer 1904 is referred to as an activation map (or feature map). The activation map includes a value for each node representing the filter results at each location of the input volume. The activation map can include an array that includes the various total sum values resulting from each iteration of the filter on the input volume. For example, the activation map will include a 24×24 array if a 5×5 filter is applied to each pixel (a stride of 1) of a 28×28 input image. The convolutional hidden layer 1904 can include several activation maps in order to identify multiple features in an image. The example shown in FIG. 19 includes three activation maps. Using three activation maps, the convolutional hidden layer 1904 can detect three different kinds of features, with each feature being detectable across the entire image.

In some examples, a non-linear hidden layer can be applied after the convolutional hidden layer 1904. The non-linear layer can be used to introduce non-linearity to a system that has been computing linear operations. One illustrative example of a non-linear layer is a rectified linear unit (ReLU) layer. A ReLU layer can apply the function f(x)=max(0, x) to all of the values in the input volume, which changes all the negative activations to 0. The ReLU can thus increase the non-linear properties of the CNN 1900 without affecting the receptive fields of the convolutional hidden layer 1904.

The pooling hidden layer 1906 can be applied after the convolutional hidden layer 1904 (and after the non-linear hidden layer when used). The pooling hidden layer 1906 is used to simplify the information in the output from the convolutional hidden layer 1904. For example, the pooling hidden layer 1906 can take each activation map output from the convolutional hidden layer 1904 and generates a condensed activation map (or feature map) using a pooling function. Max-pooling is one example of a function performed by a pooling hidden layer. Other forms of pooling functions be used by the pooling hidden layer 1906, such as average pooling, L2-norm pooling, or other suitable pooling functions. A pooling function (e.g., a max-pooling filter, an L2-norm filter, or other suitable pooling filter) is applied to each activation map included in the convolutional hidden layer 1904. In the example shown in FIG. 19, three pooling filters are used for the three activation maps in the convolutional hidden layer 1904.

In some examples, max-pooling can be used by applying a max-pooling filter (e.g., having a size of 2×2) with a stride (e.g., equal to a dimension of the filter, such as a stride of 2) to an activation map output from the convolutional hidden layer 1904. The output from a max-pooling filter includes the maximum number in every sub-region that the filter convolves around. Using a 2×2 filter as an example, each unit in the pooling layer can summarize a region of 2×2 nodes in the previous layer (with each node being a value in the activation map). For example, four values (nodes) in an activation map will be analyzed by a 2×2 max-pooling filter at each iteration of the filter, with the maximum value from the four values being output as the “max” value. If such a max-pooling filter is applied to an activation filter from the convolutional hidden layer 1904 having a dimension of 24×24 nodes, the output from the pooling hidden layer 1906 will be an array of 12×12 nodes.

In some examples, an L2-norm pooling filter could also be used. The L2-norm pooling filter includes computing the square root of the sum of the squares of the values in the 2×2 region (or other suitable region) of an activation map (instead of computing the maximum values as is done in max-pooling) and using the computed values as an output.

The pooling function (e.g., max-pooling, L2-norm pooling, or other pooling function) determines whether a given feature is found anywhere in a region of the image and discards the exact positional information. This can be done without affecting results of the feature detection because, once a feature has been found, the exact location of the feature is not as important as its approximate location relative to other features. Max-pooling (as well as other pooling methods) offer the benefit that there are many fewer pooled features, thus reducing the number of parameters needed in later layers of the CNN 1900.

The final layer of connections in the network is a fully-connected layer that connects every node from the pooling hidden layer 1906 to every one of the output nodes in the output layer 1910. Using the example above, the input layer includes 28×28 nodes encoding the pixel intensities of the input image, the convolutional hidden layer 1904 includes 3×24×24 hidden feature nodes based on application of a 5×5 local receptive field (for the filters) to three activation maps, and the pooling hidden layer 1906 includes a layer of 3×12×12 hidden feature nodes based on application of max-pooling filter to 2×2 regions across each of the three feature maps. Extending this example, the output layer 1910 can include ten output nodes. In such an example, every node of the 3×12×12 pooling hidden layer 1906 is connected to every node of the output layer 1910.

The fully connected layer 1908 can obtain the output of the previous pooling hidden layer 1906 (which should represent the activation maps of high-level features) and determines the features that most correlate to a particular class. For example, the fully connected layer 1908 can determine the high-level features that most strongly correlate to a particular class and can include weights (nodes) for the high-level features. A product can be computed between the weights of the fully connected layer 1908 and the pooling hidden layer 1906 to obtain probabilities for the different classes. For example, if the CNN 1900 is being used to predict that an object in an image is a person, high values will be present in the activation maps that represent high-level features of people (e.g., two legs are present, a face is present at the top of the object, two eyes are present at the top left and top right of the face, a nose is present in the middle of the face, a mouth is present at the bottom of the face, and/or other features common for a person).

In some examples, the output from the output layer 1910 can include an M-dimensional vector (in the prior example, M=10). M indicates the number of classes that the CNN 1900 has to choose from when classifying the object in the image. Other example outputs can also be provided. Each number in the M-dimensional vector can represent the probability the object is of a certain class. In one illustrative example, if a 10-dimensional output vector represents ten different classes of objects is [0 0 0.05 0.8 0 0.15 0 0 0 0], the vector indicates that there is a 5% probability that the image is the third class of object (e.g., a dog), an 80% probability that the image is the fourth class of object (e.g., a human), and a 15% probability that the image is the sixth class of object (e.g., a kangaroo). The probability for a class can be considered a confidence level that the object is part of that class.

FIG. 20 illustrates an example computing-device architecture 2000 of an example computing device which can implement the various techniques described herein. In some examples, the computing device can include a mobile device, a wearable device, an extended reality device (e.g., a virtual reality (VR) device, an augmented reality (AR) device, or a mixed reality (MR) device), a personal computer, a laptop computer, a video server, a vehicle (or computing device of a vehicle), or other device. For example, the computing-device architecture 2000 may include, implement, or be included in any or all of system 600 of FIG. 6, system 1000 of FIG. 10, system 1300 of FIG. 13, system 1500 of FIG. 15, system 1600 of FIG. 16 and/or other devices, modules, or systems described herein. Additionally or alternatively, computing-device architecture 2000 may be configured to perform process 700, process 1700, and/or other process described herein.

The components of computing-device architecture 2000 are shown in electrical communication with each other using connection 2012, such as a bus. The example computing-device architecture 2000 includes a processing unit (CPU or processor) 2002 and computing device connection 2012 that couples various computing device components including computing device memory 2010, such as read only memory (ROM) 2008 and random-access memory (RAM) 2006, to processor 2002.

Computing-device architecture 2000 can include a cache of high-speed memory connected directly with, in close proximity to, or integrated as part of processor 2002. Computing-device architecture 2000 can copy data from memory 2010 and/or the storage device 2014 to cache 2004 for quick access by processor 2002. In this way, the cache can provide a performance boost that avoids processor 2002 delays while waiting for data. These and other modules can control or be configured to control processor 2002 to perform various actions. Other computing device memory 2010 may be available for use as well. Memory 2010 can include multiple different types of memory with different performance characteristics. Processor 2002 can include any general-purpose processor and a hardware or software service, such as service 1 2016, service 2 2018, and service 3 2020 stored in storage device 2014, configured to control processor 2002 as well as a special-purpose processor where software instructions are incorporated into the processor design. Processor 2002 may be a self-contained system, containing multiple cores or processors, a bus, memory controller, cache, etc. A multi-core processor may be symmetric or asymmetric.

To enable user interaction with the computing-device architecture 2000, input device 2022 can represent any number of input mechanisms, such as a microphone for speech, a touch-sensitive screen for gesture or graphical input, keyboard, mouse, motion input, speech and so forth. Output device 2024 can also be one or more of a number of output mechanisms known to those of skill in the art, such as a display, projector, television, speaker device, etc. In some instances, multimodal computing devices can enable a user to provide multiple types of input to communicate with computing-device architecture 2000. Communication interface 2026 can generally govern and manage the user input and computing device output. There is no restriction on operating on any particular hardware arrangement and therefore the basic features here may easily be substituted for improved hardware or firmware arrangements as they are developed.

Storage device 2014 is a non-volatile memory and can be a hard disk or other types of computer readable media which can store data that are accessible by a computer, such as magnetic cassettes, flash memory cards, solid state memory devices, digital versatile discs (DVDs), cartridges, random-access memories (RAMs) 2006, read only memory (ROM) 2008, and hybrids thereof. Storage device 2014 can include services 2016, 2018, and 2020 for controlling processor 2002. Other hardware or software modules are contemplated. Storage device 2014 can be connected to the computing device connection 2012. In one aspect, a hardware module that performs a particular function can include the software component stored in a computer-readable medium in connection with the necessary hardware components, such as processor 2002, connection 2012, output device 2024, and so forth, to carry out the function.

The term “substantially,” in reference to a given parameter, property, or condition, may refer to a degree that one of ordinary skill in the art would understand that the given parameter, property, or condition is met with a small degree of variance, such as, for example, within acceptable manufacturing tolerances. By way of example, depending on the particular parameter, property, or condition that is substantially met, the parameter, property, or condition may be at least 90% met, at least 95% met, or even at least 99% met.

Aspects of the present disclosure are applicable to any suitable electronic device (such as security systems, smartphones, tablets, laptop computers, vehicles, drones, or other devices) including or coupled to one or more active depth sensing systems. While described below with respect to a device having or coupled to one light projector, aspects of the present disclosure are applicable to devices having any number of light projectors and are therefore not limited to specific devices.

The term “device” is not limited to one or a specific number of physical objects (such as one smartphone, one controller, one processing system and so on). As used herein, a device may be any electronic device with one or more parts that may implement at least some portions of this disclosure. While the below description and examples use the term “device” to describe various aspects of this disclosure, the term “device” is not limited to a specific configuration, type, or number of objects. Additionally, the term “system” is not limited to multiple components or specific aspects. For example, a system may be implemented on one or more printed circuit boards or other substrates and may have movable or static components. While the below description and examples use the term “system” to describe various aspects of this disclosure, the term “system” is not limited to a specific configuration, type, or number of objects.

Specific details are provided in the description above to provide a thorough understanding of the aspects and examples provided herein. However, it will be understood by one of ordinary skill in the art that the aspects may be practiced without these specific details. For clarity of explanation, in some instances the present technology may be presented as including individual functional blocks including functional blocks including devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the aspects in unnecessary detail. In other instances, well-known circuits, processes, algorithms, structures, and techniques may be shown without unnecessary detail in order to avoid obscuring the aspects.

Individual aspects may be described above as a process or method which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed but could have additional steps not included in a figure. A process may correspond to a method, a function, a procedure, a subroutine, a subprogram, etc. When a process corresponds to a function, its termination can correspond to a return of the function to the calling function or the main function.

Processes and methods according to the above-described examples can be implemented using computer-executable instructions that are stored or otherwise available from computer-readable media. Such instructions can include, for example, instructions and data which cause or otherwise configure a general-purpose computer, special purpose computer, or a processing device to perform a certain function or group of functions. Portions of computer resources used can be accessible over a network. The computer executable instructions may be, for example, binaries, intermediate format instructions such as assembly language, firmware, source code, etc.

The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, magnetic or optical disks, USB devices provided with non-volatile memory, networked storage devices, any suitable combination thereof, among others. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like.

In some aspects the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Devices implementing processes and methods according to these disclosures can include hardware, software, firmware, middleware, microcode, hardware description languages, or any combination thereof, and can take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Typical examples of form factors include laptops, smart phones, mobile phones, tablet devices or other small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are example means for providing the functions described in the disclosure.

In the foregoing description, aspects of the application are described with reference to specific aspects thereof, but those skilled in the art will recognize that the application is not limited thereto. Thus, while illustrative aspects of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, aspects can be utilized in any number of environments and applications beyond those described herein without departing from the broader spirit and scope of the specification. The specification and drawings are, accordingly, to be regarded as illustrative rather than restrictive. For the purposes of illustration, methods were described in a particular order. It should be appreciated that in alternate aspects, the methods may be performed in a different order than that described.

One of ordinary skill will appreciate that the less than (“<”) and greater than (“>”) symbols or terminology used herein can be replaced with less than or equal to (“≤”) and greater than or equal to (“≥”) symbols, respectively, without departing from the scope of this description.

Where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, A and B and C, or any duplicate information or data (e.g., A and A, B and B, C and C, A and A and B, and so on), or any other ordering, duplication, or combination of A, B, and C. The language “at least one of” a set and/or “one or more” of a set does not limit the set to the items listed in the set. For example, claim language reciting “at least one of A and B” or “at least one of A or B” may mean A, B, or A and B, and may additionally include items not listed in the set of A and B. The phrases “at least one” and “one or more” are used interchangeably herein.

Claim language or other language reciting “at least one processor configured to,” “at least one processor being configured to,” “one or more processors configured to,” “one or more processors being configured to,” or the like indicates that one processor or multiple processors (in any combination) can perform the associated operation(s). For example, claim language reciting “at least one processor configured to: X, Y, and Z” means a single processor can be used to perform operations X, Y, and Z; or that multiple processors are each tasked with a certain subset of operations X, Y, and Z such that together the multiple processors perform X, Y, and Z; or that a group of multiple processors work together to perform operations X, Y, and Z. In another example, claim language reciting “at least one processor configured to: X, Y, and Z” can mean that any single processor may only perform at least a subset of operations X, Y, and Z.

Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions.

Where reference is made to an entity (e.g., any entity or device described herein) performing functions or being configured to perform functions (e.g., steps of a method), the entity may be configured to cause one or more elements (individually or collectively) to perform the functions. The one or more components of the entity may include at least one memory, at least one processor, at least one communication interface, another component configured to perform one or more (or all) of the functions, and/or any combination thereof. Where reference to the entity performing functions, the entity may be configured to cause one component to perform all functions, or to cause more than one component to collectively perform the functions. When the entity is configured to cause more than one component to collectively perform the functions, each function need not be performed by each of those components (e.g., different functions may be performed by different components) and/or each function need not be performed in whole by only one component (e.g., different components may perform different sub-functions of a function).

The various illustrative logical blocks, modules, circuits, and algorithm steps described in connection with the aspects disclosed herein may be implemented as electronic hardware, computer software, firmware, or combinations thereof. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present application.

The techniques described herein may also be implemented in electronic hardware, computer software, firmware, or any combination thereof. Such techniques may be implemented in any of a variety of devices such as general-purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium including program code including instructions that, when executed, performs one or more of the methods described above. The computer-readable data storage medium may form part of a computer program product, which may include packaging materials. The computer-readable medium may include memory or data storage media, such as random-access memory (RAM) such as synchronous dynamic random-access memory (SDRAM), read-only memory (ROM), non-volatile random-access memory (NVRAM), electrically erasable programmable read-only memory (EEPROM), flash memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general-purpose microprocessors, an application specific integrated circuits (ASICs), field programmable logic arrays (FPGAs), or other equivalent integrated or discrete logic circuitry. Such a processor may be configured to perform any of the techniques described in this disclosure. A general-purpose processor may be a microprocessor; but in the alternative, the processor may be any conventional processor, controller, microcontroller, or state machine. A processor may also be implemented as a combination of computing devices, such as, a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein.

Illustrative aspects of the disclosure include:
Aspect 1. An apparatus for processing data, the apparatus comprising: at least one memory; and at least one processor coupled to the at least one memory and configured to: process sensor data from one or more sensors to generate bird's-eye-view (BEV) features; process the BEV features using a machine-learning model to generate an output, wherein the output comprises a number of predictions, and wherein each prediction of the number of predictions comprises a respective anchor point and a respective offset relative to the respective anchor point; and adjust an operating parameter of a vehicle based on the output.
Aspect 2. The apparatus of aspect 1, wherein the number of predictions are generated such that the respective offset of each prediction of the number of predictions is within a distance limit of the respective anchor point associated with the prediction.
Aspect 3. The apparatus of aspect 2, wherein the distance limit is greater than a mean distance between neighboring anchor points of the number of predictions.
Aspect 4. The apparatus of any one of aspects 1 to 3, wherein the anchor points of the number of predictions are uniformly distributed.
Aspect 5. The apparatus of any one of aspects 1 to 4, wherein the anchor points of the number of predictions are unevenly distributed based on a task related to the machine-learning model.
Aspect 6. The apparatus of any one of aspects 1 to 5, wherein each prediction of the number of predictions comprises a class attribute indicative of an object represented by the prediction.
Aspect 7. The apparatus of any one of aspects 1 to 6, wherein the machine-learning model is trained to detect one or more classes of objects; wherein each prediction of the number of predictions is indicative of detected object.
Aspect 8. The apparatus of any one of aspects 1 to 7, wherein the apparatus comprises a computing system of a vehicle.
Aspect 9. The apparatus of any one of aspects 1 to 8, wherein the operating parameter is associated with at least one of a path for the vehicle to travel, a steering parameter for operating steering of the vehicle, a braking parameter for operating brakes of the vehicle, a lane-change parameter for causing the vehicle to navigate from a first lane to a second lane, or displaying information related to the output using a user interface of the vehicle.
Aspect 10. The apparatus of any one of aspects 1 to 9, wherein the sensor data comprises at least one of: image data from at least one camera; radio detection and ranging (RADAR) data from at least one RADAR system; or light detection and ranging (LIDAR) data from at least one LIDAR system.
Aspect 11. The apparatus of any one of aspects 1 to 10, wherein the sensor data comprises: first image data from a first camera; and second image data from a second camera.
Aspect 12. The apparatus of any one of aspects 1 to 11, wherein the sensor data comprises: image data from a camera; and LIDAR data from a LIDAR system.
Aspect 13. The apparatus of any one of aspects 1 to 12, wherein the sensor data comprises: LIDAR data from a LIDAR system.
Aspect 14. The apparatus of any one of aspects 1 to 13, wherein the sensor data comprises: image data from a camera; and RADAR data from a RADAR system.
Aspect 15. The apparatus of any one of aspects 1 to 14, wherein the sensor data comprises: RADAR data from a RADAR system.
Aspect 16. The apparatus of any one of aspects 1 to 15, wherein the sensor data comprises: image data from a camera; LIDAR data from a LIDAR system; and RADAR data from a RADAR system.
Aspect 17. The apparatus of any one of aspects 1 to 16, wherein the sensor data is processed using an encoder machine-learning model to generate feature data, wherein the at least one processor is configured to project the feature data to generate the BEV features.
Aspect 18. A method for processing data, the method comprising: processing sensor data from one or more sensors to generate bird's-eye-view (BEV) features; processing the BEV features using a processing head to generate an output, wherein the output comprises a number of predictions, and wherein each prediction of the number of predictions comprises a respective anchor point and a respective offset relative to the respective anchor point; and adjusting an operating parameter of a vehicle based on the output.
Aspect 19. The method of aspect 18, wherein the number of predictions are generated such that the respective offset of each prediction of the number of predictions is within a distance limit of the respective anchor point associated with the prediction.
Aspect 20. The method of aspect 19, wherein the distance limit is greater than a mean distance between neighboring anchor points of the number of predictions.
Aspect 21. The method of any one of aspects 18 to 20, wherein the anchor points of the number of predictions are uniformly distributed.
Aspect 22. The method of any one of aspects 18 to 21, wherein the anchor points of the number of predictions are unevenly distributed based on a task related to the processing head.
Aspect 23. The method of any one of aspects 18 to 22, wherein each prediction of the number of predictions comprises a class attribute indicative of an object represented by the prediction.
Aspect 24. The method of any one of aspects 18 to 23, wherein the machine-learning model is configured to detect one or more classes of objects; wherein each prediction of the number of predictions is indicative of detected object.
Aspect 25. The method of any one of aspects 18 to 24, wherein the operating parameter is associated with at least one of a path for the vehicle to travel, a steering parameter for operating steering of the vehicle, a braking parameter for operating brakes of the vehicle, a lane-change parameter for causing the vehicle to navigate from a first lane to a second lane, or displaying information related to the output of the task using a user interface of the vehicle.
Aspect 26. The method of any one of aspects 18 to 25, wherein the sensor data comprises at least one of: image data, radio detection and ranging (RADAR) data, or light detection and ranging (LIDAR) data.
Aspect 27. The method of any one of aspects 18 to 26, wherein the sensor data comprises: first image data from a first camera; and second image data from a second camera.
Aspect 28. The method of any one of aspects 18 to 27, wherein the sensor data comprises: image data from a camera; and light detection and ranging (LIDAR) data from a LIDAR system.
Aspect 29. The method of any one of aspects 18 to 28, wherein the sensor data comprises: light detection and ranging (LIDAR) data from a LIDAR system.
Aspect 30. The method of any one of aspects 18 to 29, wherein the sensor data comprises: image data from a camera; and radio detection and ranging (RADAR) data from a RADAR system.
Aspect 31. The method of any one of aspects 18 to 30, wherein the sensor data comprises: radio detection and ranging (RADAR) data from a RADAR system.
Aspect 32. The method of any one of aspects 18 to 30, wherein the sensor data comprises: image data from a camera; light detection and ranging (LIDAR) data from a LIDAR system; and radio detection and ranging (RADAR) data from a RADAR system.
Aspect 33. The method of any one of aspects 18 to 30, wherein the sensor data is processed using an encoder machine-learning model to generate feature data, the method further comprising projecting the feature data to generate the BEV features.

What is claimed is:

1. An apparatus for processing data, the apparatus comprising:
at least one memory; and
at least one processor coupled to the at least one memory and configured to:
process sensor data from one or more sensors to generate bird's-eye-view (BEV) features;
process the BEV features using a machine-learning model to generate an output, wherein the output comprises a number of predictions, and wherein each prediction of the number of predictions comprises a respective anchor point and a respective offset relative to the respective anchor point; and
adjust an operating parameter of a vehicle based on the output.

2. The apparatus of claim 1, wherein the number of predictions are generated such that the respective offset of each prediction of the number of predictions is within a distance limit of the respective anchor point associated with the prediction.

3. The apparatus of claim 2, wherein the distance limit is greater than a mean distance between neighboring anchor points of the number of predictions.

4. The apparatus of claim 1, wherein the anchor points of the number of predictions are uniformly distributed.

5. The apparatus of claim 1, wherein the anchor points of the number of predictions are unevenly distributed based on a task related to the machine-learning model.

6. The apparatus of claim 1, wherein each prediction of the number of predictions comprises a class attribute indicative of an object represented by the prediction.

7. The apparatus of claim 1, wherein the machine-learning model is trained to detect one or more classes of objects; wherein each prediction of the number of predictions is indicative of detected object.

8. The apparatus of claim 1, wherein the apparatus comprises a computing system of a vehicle.

9. The apparatus of claim 1, wherein the operating parameter is associated with at least one of a path for the vehicle to travel, a steering parameter for operating steering of the vehicle, a braking parameter for operating brakes of the vehicle, a lane-change parameter for causing the vehicle to navigate from a first lane to a second lane, or displaying information related to the output using a user interface of the vehicle.

10. The apparatus of claim 1, wherein the sensor data comprises at least one of: image data, radio detection and ranging (RADAR) data, or light detection and ranging (LIDAR) data.

11. The apparatus of claim 1, wherein the sensor data comprises:
first image data from a first camera; and
second image data from a second camera.

12. The apparatus of claim 1, wherein the sensor data comprises:
image data from a camera; and
light detection and ranging (LIDAR) data from a LIDAR system.

13. The apparatus of claim 1, wherein the sensor data comprises:
light detection and ranging (LIDAR) data from a LIDAR system.

14. The apparatus of claim 1, wherein the sensor data comprises:
image data from a camera; and
radio detection and ranging (RADAR) data from a RADAR system.

15. The apparatus of claim 1, wherein the sensor data comprises:
radio detection and ranging (RADAR) data from a RADAR system.

16. The apparatus of claim 1, wherein the sensor data comprises:
image data from a camera;
light detection and ranging (LIDAR) data from a LIDAR system; and
radio detection and ranging (RADAR) data from a RADAR system.

17. The apparatus of claim 1, wherein the sensor data is processed using an encoder machine-learning model to generate feature data, wherein the at least one processor is configured to project the feature data to generate the BEV features.

18. A method for processing data, the method comprising:
processing sensor data from one or more sensors to generate bird's-eye-view (BEV) features;
processing the BEV features using a processing head to generate an output, wherein the output comprises a number of predictions, and wherein each prediction of the number of predictions comprises a respective anchor point and a respective offset relative to the respective anchor point; and
adjusting an operating parameter of a vehicle based on the output.

19. The method of claim 18, wherein the number of predictions are generated such that the respective offset of each prediction of the number of predictions is within a distance limit of the respective anchor point associated with the prediction.

20. The method of claim 19, wherein the distance limit is greater than a mean distance between neighboring anchor points of the number of predictions.
